(19) United States
(12) Patent Application Publication
(10) Pub. No.: US 2004/0081951 A1
(43) Pub. Date: Apr. 29, 2004

(54) Work/training using an electronic infrastructure

(76) Inventors: Michael Vigue, Windham, NH (US); Jane Blankenship, North Chatham, MA (US); Kerry Johnson, Andover, MA (US); Catherine Lang, Somerville, MA (US); Shail Chotai, Windham, NH (US)

Correspondence Address: FISH & RICHARDSON PC, 225 FRANKLIN ST, BOSTON, MA, 02110, US

(21) Appl. No.: 10/600,172

(22) Filed: Jun. 20, 2003

Related U.S. Application Data
(63) Continuation of application No. 09/591,200, filed on Jun. 9, 2000, now abandoned.

(51) Int. Cl. G09B 3/00

(52) U.S. Cl. 434/350

(57) ABSTRACT

A method includes. (a) electronically enabling people who belong to an enterprise to define a goal that is related to managing a relationship with a customer of the enterprise; (b) providing a graphical user interface that enables the people to cooperate to make complex decisions that will advance the achievement of the goal; and (c) providing features in the interface that enable the people to make the complex decisions in a manner that inherently and continually improves their ability to make subsequent complex decisions.

### BACKGROUND

This invention relates to work/training using an electronic infrastructure.

In one paradigm for work/training, people to be trained are removed from their normal work duties and environment and sent to onsite or offsite training sessions. Studies show that although these events initially increase worker productivity above a competency threshold level 100, as suggested by the upward curve 102 of productivity in FIG. 1, the knowledge obtained at these events fades and the worker's productivity level often reverts 104 to near a baseline level 106 that existed before the session.

To reduce disruption to the trainee's work, training sessions may include (or be replaced by) online training lessons that can be delivered at the trainee's workstation. The trainee still must stop his or her normal work to run through each of the lessons. Online lessons may provide useful information and reduce the size of each block of time taken away from every-day work. They also can increase productivity after each lesson 200, 202, 204, 206 and eventually above a competency threshold level 208 as shown in FIG. 2. Over a period of time, however, trainees may tire of the lessons and rarely run through them or stop doing them 210. Completion of online lessons may not be monitored and trainees may never finish them. As a result, the projected benefits may never be met in reality 212.

With both training events and online lessons, a trainee may forget or lose the information that was taught before the trainee has an occasion to apply the information to his or her work. Sometimes the training fails to teach the trainee how to use the information in a real work environment, leaving the trainee confused.

The need for effective, timely, and continuous work/training is becoming more acute as organizations continuously reorganize themselves to improve their ability to compete, grow, and adapt. Among currently popular modes of developing and implementing new organizational strategies are enterprise resource planning (ERP) and customer relationship management (CRM). Implementing new organizational strategies involves a complex interaction among information resources, technology infrastructure, and people. Thus, while training has become a more critical requirement for an organization to be competitive and effective, and typical training methods are not adequately effective, the time and money available for training has decreased.

A key strategic goal for many organizations is building or improving customer relationships to maintain a strong customer base. Maintaining a strong customer base often requires determining a customer's needs and how best to fulfill those needs. However, gathering up-to-date and relevant information on each customer from a wide variety of sources internal to and external to the organization can be complicated. Even if information is gathered, the difficulty in integrating the information into a consistent customer relationships strategy throughout the organization may prevent effective or full use of the information.

One type of organization, a network company 300, shown in FIG. 3, may be particularly interested in maintaining a strong customer base. The network company 300 is a highly complex organization where customer relationships involve more than simple product transactions. The network company 70 manages highly complex customer relationships that demand constant and varied interactions and solutions to diverse customer issues. The network company 300 combines a front-end operation of knowledge workers 302 providing customized products and services to customers-304 with a back-end operation of non-knowledge workers 306 such as managers who continually innovating, improving, and developing the products and services. The non-knowledge workers 306 also may engage in straight product sales to or purchases from customers 308 (who may or may not include the same customers as the knowledge workers' customers 304). To maintain and properly serve the customers 304, 308, the knowledge workers 302 and the non-knowledge workers 306 must constantly provide their knowledge and feedback to each other. However, even if the network company 300 achieves this knowledge and feedback exchange, it is difficult for the knowledge workers 306 and the non-knowledge workers 306 to figure out how to apply the knowledge and feedback to a particular customer and in a particular context.

### SUMMARY

In general, in one aspect, the invention features a method that includes (a) electronically enabling people who belong to an enterprise to define a goal that is related to managing a relationship with a customer of the enterprise; (b) providing a graphical user interface that enables the people to cooperate to make complex decisions that will advance the achievement of the goal; and (c) providing features in the interface that enable the people to make the complex decisions in a manner that inherently and continually improves their ability to make subsequent complex decisions.

In general, in another aspect, the invention features a method that includes (a) generating an overview computer screen for a worker, the overview screen containing information on one or-more customers associated with the worker and information on one or more projects associated with the worker; (b) generating a customer computer screen for a customer on the overview computer screen when the worker requests information on the customer; (c) generating a project computer screen for a project on the overview computer screen when the worker requests information on the project; and (d) filtering the information on the overview, customer, and project screens based on an access level of the worker.

In general, in another aspect, the invention features an article comprising a computer-readable medium which stores computer-executable instructions, the instructions causing a computer to (a) provide workers in an organization with access to a customer interface environment including data on customers of the organization and projects related to the customers and to a game environment providing simulations of real-world scenarios involving the customers and the projects; and (b) allow the workers to freely switch between the customer interface environment and the game environment.

In general, in another aspect, the invention features an article comprising a computer-readable medium which stores computer-executable instructions, the instructions causing a computer to (a) store data on a number of customers associated with an organization; (b) store data on a number of projects related to the customers; and (c) automatically provide a worker in the organization with data received from sources internal to and external to the organization relating to customers and to projects associated with the worker.

In general, in another aspect, the invention features an electronic game environment comprising (a) simulated personas of parties to the game, the personas being defined in a manner that relates to customer relationship management, (b) simulated roles of parties of the game, the roles being defined in a manner that relates to customer relationship management, (c) simulated activities that relate to customer relationship management, and (c) simulated levels of play that relate to different levels of complexity of customer relationship management.

In general, in another aspect, the invention features an electronic story creation environment comprising (a) a storyteller facility in which a user can enter elements of a story, (b) a scenario builder that enables a user to create a scenario associated with a story, (c) a what-if scenario builder that enables a user to create a scenario associated with alternative possible hypotheses, and (d) a case create facility that enables a user to format a history of activity into a case for later use.

In general, in another aspect, the invention features an electronic user interface comprising (a) a map that illustrates relationships among members of a team working on an enterprise management task, (b) the relationships being illustrated in a manner that identifies the significance of the role of each member within the team, (c) the relationships being illustrated in a manner that identifies the frequency of interaction of the user of the interface with other members of the team.

In general, in another aspect, the invention features an electronic user interface comprising (a) a map that illustrates relationships between a user of the interface and a set of people who represent mentors of the user, and (b) windows that display details about each of the mentors.

In general, in another aspect, the invention features an electronic user interface comprising (a) a facility that automatically assembles and displays a history of communications and activities among members of a team who are working on an enterprise task, and (b) a facility to annotate and manipulate the information in the window to form the history into a case that can be studied by others who are working on similar tasks.

In general, in another aspect, the invention features an electronic user interface comprising (a) a facility that guides a user in creating a story associated with an enterprise task, (b) the facility including a graphical display of portions of a story in accordance with a selected one of a set of predefined story themes.

One or more of the following advantages may be provided by one or more aspects of the invention.

The software (electronic infrastructure) can:

push only pertinent information to the worker through filters and business logic;

drive experimentation and scenario testing;

deliver the right advice and counsel from peers and experts at the point of need;

spark, capture, and share insights within and across teams;

connect customers to the insight process; and

create a unique environment that drives insightful solutions.

By sharing the same tools, speaking the same language, and using the same methods, an organization and its customers increase speed and innovation. The customer relationship is more engaging, more valuable, and significantly harder for either party to walk away from—it becomes a differentiated experience.

The software (electronic infrastructure) can provide a work environment that is “virtual real-life,” where skills, knowledge, tools, techniques, information, learning, and experiences are integrated. The results may include:

increased productivity, innovation, and insight;

increased competence and intellectual capital;

improved personalized solutions;

increased speed of solutions and decisions;

a differentiated customer experience that is difficult to replicate;

decreased cost of learning; and

increased insight and learning from the job.

Other advantages and features will become apparent from the following description and from the claims.

### DESCRIPTION OF DRAWINGS

FIG. 1 is a graph showing a learning curve for event-based learning.

FIG. 2 is graph showing learning curves for online-based learning.

FIG. 3 is a block diagram showing a structure of a company.

FIG. 4 is a diagram showing a network arrangement.

FIG. 5 is a block diagram of an electronic infrastructure in accordance with an implementation of the invention.

FIG. 6 shows an initial/overview screen in accordance with an implementation of the invention.

FIG. 7 is a graph showing a learning curve for inline-based learning in accordance with an implementation of the invention.

FIG. 8 shows an electronic infrastructure engine in accordance with an implementation of the invention.

FIG. 9 shows a customer screen in accordance with an implementation of the invention.

FIG. 10 is a block diagram showing components of the electronic infrastructure of FIG. 5.

FIG. 11 is a block diagram showing applications of the electronic infrastructure of FIG. 5.

FIGS. 12-23 show screens in accordance with an implementation of the invention.

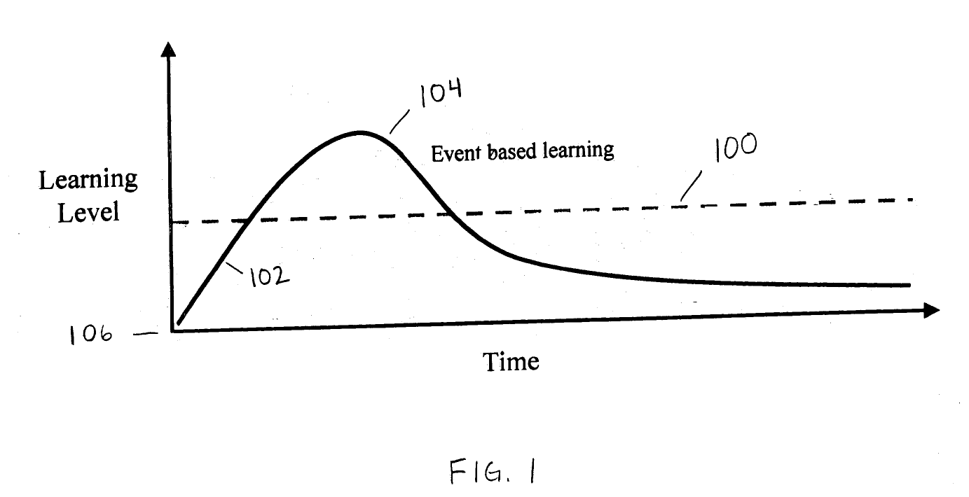

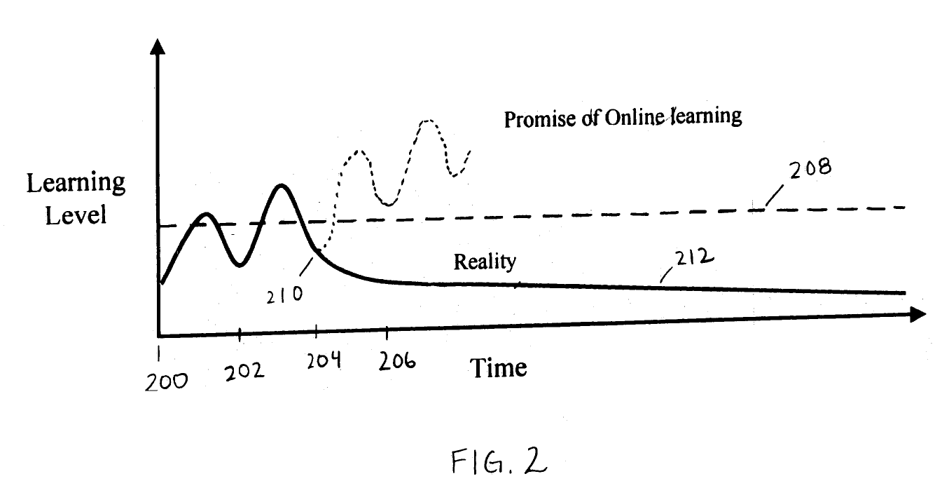

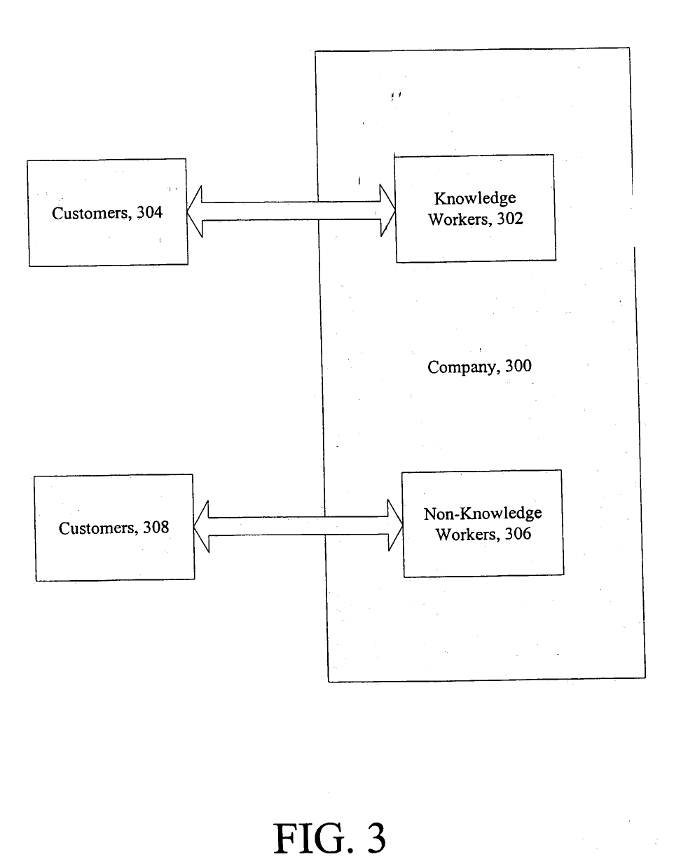

### DESCRIPTION

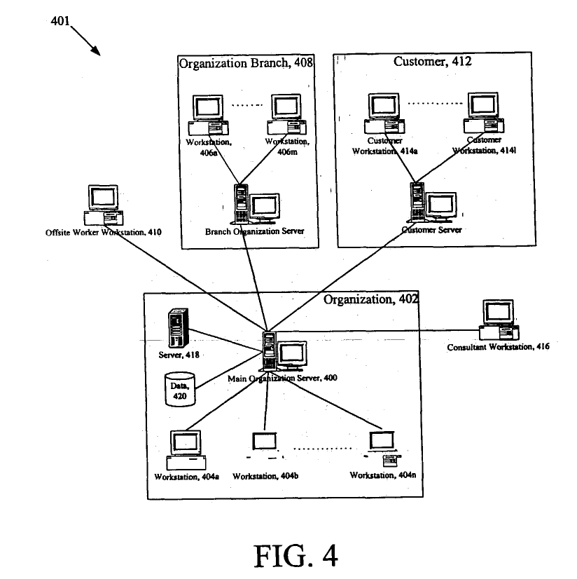

Referring to FIG. 4, a network arrangement 401 including an electronic infrastructure (described below) in a server 400 maintained by an organization 402 in accordance with an implementation of the invention allows workers in the organization 402 to experience fully integrated, repetitive, online, and continual training as part of their every-day work environment at their individual workstations. “Workers” can include employees of the organization 402 at the workstations 404a-h, at branch workstations 406a-m located at a branch 408 of the organization 402, and at an offsite worker workstation 410, employees of a customer 412 of the organization 402 at customer workstations 414a-l, and outside individuals, e.g., a consultant at a consultant workstation 416, who have access to the electronic infrastructure. In effect, the workers learn while working and work while learning. Learning and working are tightly linked to reduce the cost and disruption and to improve the effectiveness of training and to improve the quality and reduce the cost of work being done. The training is not done by stopping work and engaging in training using an online lesson, after which the worker stops training and returns to working. Rather the work environment is structured in such a way that training goes on continually as part of working, and vice versa.

The employees of the organization 402 can also use the electronic infrastructure to support and bolster complex, high-end, business to business relationships, such as with clients or the customer 412. These relationships often involve making complex decisions which:

involve more than two people in the decision-making process;

have no single correct solutions;

involve multiple factors;

potentially have long-term, multi-level impact on most of the parties involved;

have a multitude of possible outcomes that lead to uncertainty about long-term effects;

directly connect to previous and future decisions;

lead to subsequent decision points;

can be, and often are, altered after the original decision; and

require the knowledge of many people.

Inventing and sustaining distinctive customer relationships is increasingly becoming more important in gaining a competitive edge. The electronic infrastructure offers three components to help create and maintain such customer relationships, i.e., to help build customer equity: 1) an engine that can choreograph and manage all activities of the electronic infrastructure; 2) a persistent world, game environment that allows individuals and teams to collaboratively develop and test ideas, assumptions, and strategies as part of their work; and 3) a customer interface, business environment that provides a number of applications that can enable faster, deeper, and systematic and intuitive analysis of customer situations.

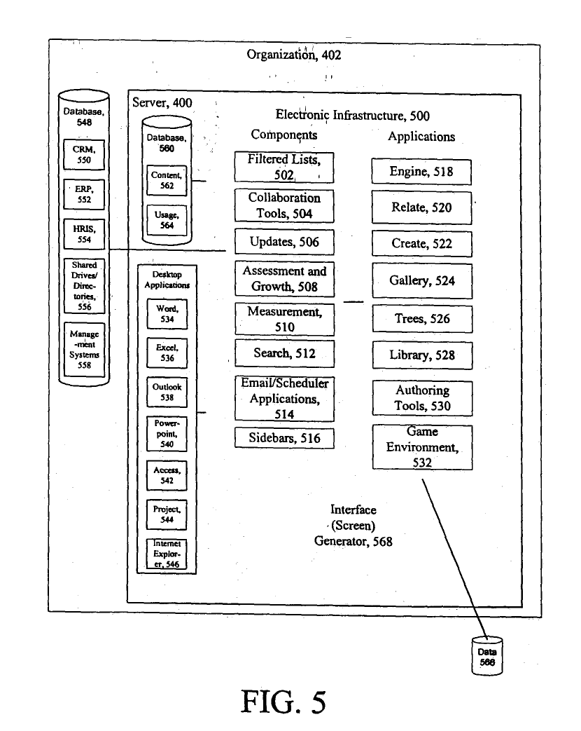

An electronic infrastructure 500, as shown in FIG. 5, is stored as a software system on the server 400 and/or on a server 418 or database 420 accessible by the server 400. The electronic infrastructure 500 runs on the server 400 and manages the relationships between a number of components 502-516 and applications 518-532 included in the electronic infrastructure 500, and desktop applications, e.g., Microsoft applications 534-546 stored on the server 400 and accessible by the electronic infrastructure 500. The components 502-516 include work tools and data information sources including filtered lists 502, collaboration tools 504, updates 506, assessment and growth tools 508, measurement tools 510, search tools 512, electronic mail/scheduler applications 514, and sidebars 516 (each described further below). The applications 518-532 include applets designed to facilitate working and learning, such as an engine 518, a relate tool 520, a create tool 522, a gallery 524, trees 526, a library 528, authoring tools 530, and a game environment 532. The Microsoft applications 534-546 include those desktop applications the worker may frequently use in his or her every-day work, such as Word 534, Excel 536, Outlook 538, Powerpoint 540, Access 542, Project 544, and Internet Explorer 546. The electronic infrastructure 500 provides the visual framework for each worker's workstation 404, 406, 410, 414, 416 using an interface (screen) generator 568.

The data used in the components 502-546, applications 518-532, and desktop applications 534-546 comes from a number of data sources accessible by the electronic infrastructure 500. An organization-database 548 accessible by the server 400 includes data related to the organization and its workers.

For example, the organization database 548 can include CRM data 550, ERP data 552, human resource information systems (HRIS) data 554, corporate network shared drive/directories 556, and project management and knowledge management systems 558. The organization database 548 may be one or more independent databases. The data included in the organization database 548 can allow the electronic infrastructure 500 to analyze, refine, and evaluate multiple sources of customer data and to work collaboratively on the data so that collective intelligence of worker teams can be used. An electronic infrastructure database 560 included on the server 400 (or within the electronic infrastructure 500) includes data relating to the content and usage of the electronic infrastructure 500. A content database 562 can include data 20‘related to the organization’s customers and projects. A usage database 564 can include data generated from worker usage of the electronic infrastructure 500 such as work product generated by workers such as documents and posted messages, a worker's access rights, and projects and customers associated with a particular worker. Outside data sources 566 can provide news feeds to the electronic infrastructure 500. The outside data sources 566 can include one or more data sources accessible over a network such as the Internet, in which case the outside data sources 566 could include third party news feeds and favorite websites. The electronic infrastructure 500 provides agents (spiders) crawling the outside data sources 566 for data.

The interface generator 568 provides to each worker a worker (user) interface that is at the heart of the most everyday work activities performed by the worker. It represents a continually used and personal portal for internal and external information, mentoring resources, applications, and work/training. The worker performs much or his or her work/training in the personal portal.

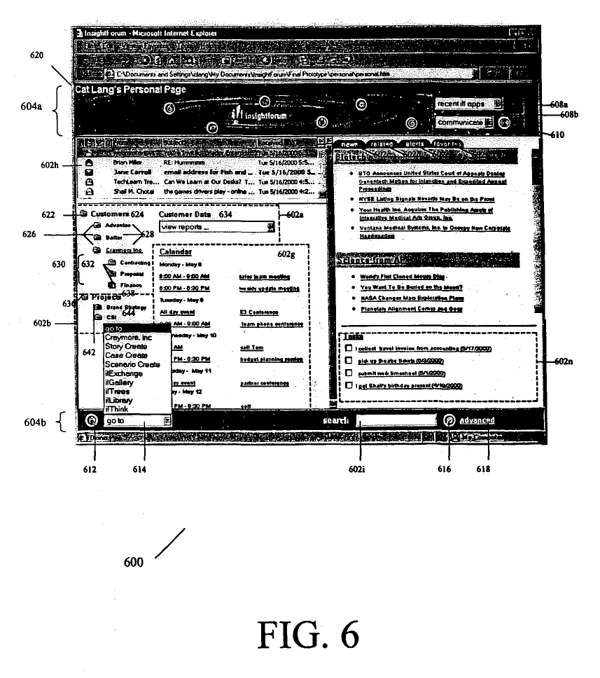

Each worker has access to a personal initial/overview screen 600 shown in FIG. 6 and generated by the electronic infrastructure 500. A worker's initial/overview screen 600 includes sections 602a-n of information tailored to the worker and gathered and disseminated by the electronic infrastructure 500. The worker can customize the view/layout of his or her initial/overview screen. The sections 602a-n provide an interface for the worker to train and learn various aspects of his or her job as he or she encounters them during the performance of productive work while enabling the organization to disseminate customer information and implement consistent re-engineering strategies. Each section 602a-n can perform independently, but each can relate to other sections 602a-n as enabled by the electronic infrastructure 500.

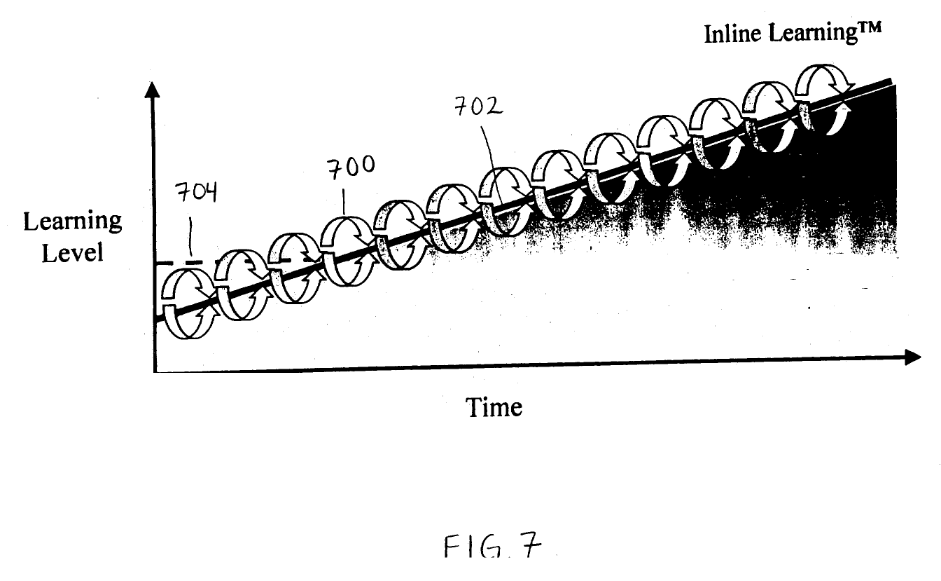

Linking a worker's training with his or her every-day work via the initial/overview screen 600 creates an inline process of learning that provides continually repeated cycles of learning 700 as shown in FIG. 7. Because the worker receives repetitive, online, and continual training and learning as part of working by using the different sections 602a-n, the cycles 700 can achieve a continually upward sloping curve of productivity 702 that exceeds a competency threshold level 704 over a long period of time. Merging training with real tasks enables workers to learn how to more productively and effectively perform their jobs while at the same time providing real work product that can be used for future reference. Further, integrating the worker's learning experience into the electronic infrastructure 500 provides other workers in the organization with access to that experience and enables the organization to learn as a whole and more effectively implement a consistent and effective business strategy.

The sections 602a-n can include lists called dashboards. The purpose of a list is to provide workers with up-to-date, individually-tailored information relating to their every-day work tasks. Lists can include data drawn from data sources used by the organization, e.g., ERP, CRM, and HRIS data from the organization database, from the electronic infrastructure database, and/or from outside data sources (see FIG. 5). The data displayed in a list depends on an access level of the worker and the screen from which the list is accessed. Examples of lists on and/or linked to from the initial/overview screen 600, described further below, include a customer dashboard 602a, a project dashboard 602b, related clients/projects 602d, contacts, personal networks, communities, alerts/updates/notifications 602e, internal and/or external news 602c, instant messaging and chat, threaded discussions, shared whiteboards, favorites 602f, a scheduler/calendar 602g, electronic mail (email) 602h, opportunities (not shown), a search engine 602i, tasks 602n, and assessment tools (not shown). Some of the lists 602a-n can be accessible by clicking on a tab, such as shown for the news 602c, the related clients/projects 602d, the alerts/updates/notifications 602e, and the favorites 602f. Clicking on a tab displays information for that list so that only one of the lists may be displayed at one time (although this may be configurable to display multiple lists).

The initial/overview screen 600 can also include sidebars such as a top sidebar (header) 604a and a bottom sidebar (footer) 604b that display icons and/or menus that workers may click on to navigate through the electronic infrastructure 500. At least some portions of the top sidebar 604a and the bottom sidebar 604b are available to the worker at all times to facilitate easy maneuvering throughout the electronic infrastructure 500.

The top sidebar 604a includes icons 606a-f linked to various applications and/or menus of various applications. (The applications could be separately listed instead of conserving space by using icons.) When the worker moves his or her mouse pointer over an icon, clicks on the icon, or otherwise accesses the icon, a list of applications appears. The applications can include desktop applications (see FIG. 5) including a browser (Internet Explorer 546), an email/scheduler (Microsoft Outlook 538), a word processor (Microsoft Word 534), a presentation tool (Microsoft PowerPoint 540), a database tool (Microsoft Access 542), a spreadsheet tool (Microsoft Excel 536), and a project tool (Microsoft Project 544). Other applications may include applications functioning as applets that act as tools that a worker or a team of workers can use to make decisions and solve problems. These applications can include a practice tool (the game environment 532), a communicate tool (the relate tool 520), an applications tool (the gallery tool 524), the create tool 522, the library 528, the engine 518, the trees 526, and the authoring tools 530.

The top sidebar 604a also includes two drop-down menus: a recent applications menu 608a and a communicate menu 608b. When the recent applications menu 608a is dropped down (as shown for a go-to menu 614, described below), a list of applications appears that the worker has recently accessed. “Recently accessed” could mean in any time frame programmed into the electronic infrastructure 500 as a default setting, as set by the organization, or as set by the worker, e.g., past five hours or past seven days. When the worker clicks on a recently accessed application, that application launches. The communicate menu 608b, when dropped down, lists a variety of communication tools such as instant messaging, chat, and threaded discussions. The worker can launch a listed communications tool by selecting (highlighting) the communications tool and activating a communication icon 610 (described above). The tools, instead of being part of the communicate menu 608b, may be listed individually on the top sidebar 604a.

The top sidebar 604a could also include a recent documents/projects drop-down menu (not shown). The recent documents/projects menu performs like the recent applications menu 608a but shows recently accessed documents or projects as opposed to recently accessed applications. When the worker clicks on a recently accessed document or project, the clicked-on document or project loads.

The bottom sidebar 604b provides navigation tools to the worker. A home icon 612 allows the worker to jump to his or her initial/overview screen 600. The go-to menu 614 is a drop-down menu that lists applications and/or other electronic infrastructure screens, e.g., Craymore, Inc. (a customer screen) that the worker can choose to access. The search engine 602i enables a worker to search the electronic infrastructure 500 for, e.g., project teams, communities, stories, or discussion threads. The worker can execute the search by accessing a search icon 616. Advanced searching is available by clicking on an advanced search link 618.

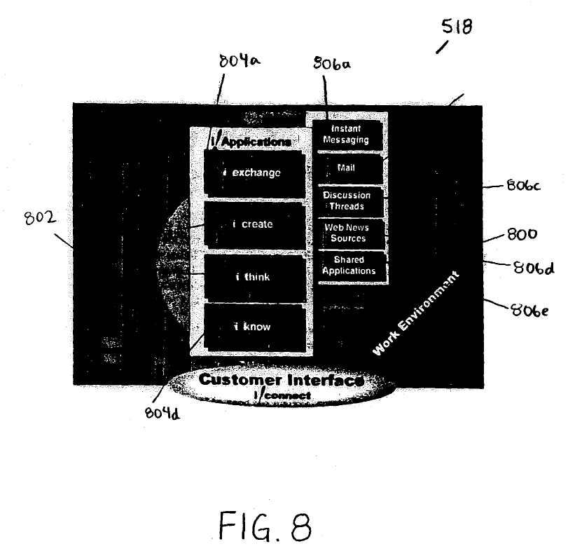

Referring to FIG. 8, the engine 518 (FIG. 5) acts as a primary administration/configuration tool for the electronic infrastructure that allows the organization to determine which data sources provide data to the lists and to other applications. The engine 518 choreographs and manages most, if not all, activities of the electronic infrastructure 500. Capabilities of the engine 518 can include:

providing high-powered, flexible knowledge management based on the development of concepts. By automatically analyzing content and contributions to the organization database 548 (or other database) for conceptual threads, the engine 518 can build both a coherent library of knowledge and a database of experts who can be called on by a worker or team of workers as mentors or subject matter experts.

providing templates and tracking to facilitate the creation of rapid, collaborative, and communicative equipment.

providing filters and agents that focus the flow of information in and out of the electronic infrastructure 500. The filters provide personalized information as well as push the applications and data to the worker when appropriate according to how the electronic infrastructure 500 is being used.

directing workers and teams of workers toward appropriate activities that facilitate work and extend their individual and group capabilities.

When a worker encounters a task requiring attention, e.g., an unfamiliar customer request, a problem the worker is unsure how to approach, a news bulletin, or similar task appearing on a list, the worker can use the engine 518 to access another application(s) that can provide information and/or training on how to handle the task simultaneously with the worker doing the task. The worker experiences both training and learning in a single mechanism that may encourage worker productivity, customer support, competitive advantages, customer loyalty, and lasting worker knowledge. In this way, the worker can train on an as-needed basis and in his or her every-day work environment while the organization may implement re-engineering strategies in a manner accessible to and understandable by all workers.

Conceptually, in one implementation, the engine 518 enables workers to work and learn essentially simultaneously using two separate but related and overlapping environments: a customer interface environment 800 and a game environment 802. The customer interface environment 800 includes applications 804a-d such as those included in the top sidebar 604a (FIG. 6) and lists 806a-e that can tailor the customer interface environment 800 to the worker. The game environment 802 (accessible through the top sidebar 604a and/or the bottom sidebar 604b) includes a highly graphic environment meant to offer an alternate worldview to the worker that parallels and responds to business decisions and activities in the real world. The game environment 802 uses the applications 804a-d and the lists 806a-e to allow the worker to simulate the instant task by using various courses of action and by visualizing a variety of outcomes based on factors including prior experiences of the organization, prior experiences of the organization's workers, policies of the organization, and real-world occurrences.

By the time the worker explores one or both environments 800, 802, the worker has likely created real work product, engaged in training, and provided data to the engine 518 for future use by any of the workers in the organization (subject to each worker's access level). The engine 518 and other applications are described in more detail below.

When a worker initially encounters the electronic infrastructure 500, e.g., by logging onto the organization's computer network system on the organization's main server at his or her workstation (as in FIG. 4) to gain access to his or her working environment (the screens of the electronic infrastructure 500 and first the initial/overview screen), the worker automatically becomes aware of his or her access credentials to the electronic infrastructure 500. For example, only certain dashboards may be shown, with other dashboards not accessible at all. Rather than creating an additional login procedure for the electronic infrastructure 500, it is expected that the electronic infrastructure 500 can utilize the organization's network login for worker security and access level.

Components of each screen of the electronic infrastructure 500 come from various sources (assuming they exist at the organization, the items marked with an asterisk are required), including (as shown in FIG. 5):

the organization's CRM data 550, for example, information pertaining to sales and marketing for each customer/client of the organization;*

the organization's HRIS data 554, for example, personal profiles on all workers associated with the organization;*

the organization's ERP data 552, for example, information pertaining to the organization's plans, sales, and marketing strategies for particular customers/clients;

the organization's electronic mail (email) and/or scheduler applications 514, e.g., Microsoft Outlook 2000/Exchange 5.5/2000 Server Application;*

the organization's corporate network shared drives/directories 556, e.g., lightweight directory access protocol (LDAP), network terminals (NT), and active directory worker profiles;*

the organization's project management and knowledge management systems 558;

news feeds 566;

the electronic interface's applications 518-532;*

the electronic interface's content database 562;* and

the electronic interface's usage database 564.

The applications that the worker has access to can be determined by the worker's:

access level (role);

team membership;

client assignments;

project involvement; and

community participation.

Any data from existing CRM, ERP or HRIS systems can be leveraged to determine the worker's roles and assignments. All data entered by the workers relating to their roles and memberships thereon can be stored in the electronic infrastructure database and reported to the organization as an add-on service.

The electronic infrastructure 500 can be personalized for different organizations. Basic data on an organization can be obtained from the organization's HRIS and/or CRM databases and added to and throughout the electronic infrastructure 500 (particularly the application set-up and administration tools, described below) and profiles developed through participation in the electronic infrastructure's inline learning applications. Thus, the electronic infrastructure 500 includes a data import mechanism and a way to regularly update databases included in the electronic infrastructure 500. Imported information is not editable unless there is a mechanism to feed the new data back (some of the information is editable, and these edits reside in the electronic infrastructure database, supplementing the HRIS and/or CRM feeds). Thus, for example, referring to FIG. 5, the electronic infrastructure 500 may be configured to import data on a worker from the HRIS data 554 and to include the imported data in a filtered list 502 such as a contacts list. Workers who access the imported data in the contacts list may view the data but not change it unless the worker making the changes has a particular access level and the electronic infrastructure 500 is configured to export the changed data back to the HRIS data system 554 in the organization database 548.

The initial/overview screen 600 of FIG. 6 is the central point from where all work/learning proceeds. The initial/overview screen 600 is the first screen accessed by the worker after login and gives him or her access to the information and tools needed to perform his or her every-day tasks and participate on assigned projects. The information displayed on the initial/overview screen 600 (and all other screens, applications, and tools) is personalized, meaning that it is filtered based on the worker, including the worker's access rights/level, team membership, and project participation. The worker's name 620 appears at the top of the initial/overview screen 600. Where possible, the worker is able to configure the information on each of these screens by choosing from lists of options. (The workers have access to a VB/C++ application that enables them to customize the XML-oriented dashboard overview screens.) Components of the initial/overview screen 600 may include:

customer dashboard 602a (containing information for a particular customer);

project dashboard 602b (containing information for a particular project);

related customers/projects 602d;

opportunities (not shown);

personal network (not shown);

communities (not shown) (teams and related, participating teams);

email/scheduler applications 602h/602g;

instant messaging and chat (involving personal network members) (not shown);

threaded discussions (not shown);

shared whiteboards (not shown);

favorites 602f (accessible by clicking on the shown link/title, e.g., bookmarked web links and frequently accessed document-s)

alerts/updates/notification 602e (accessible by clicking on the shown link/title);

other/internal/external news 602c (full document available by clicking on the shown link/title);

contacts (not shown) (filtered to show the entire organization worker list and contacts from the worker's teams and communities);

management information, for example, progress against targets/goals and top accounts;

search engine 602i;

sidebars 604a and 604b;

tasks 602n; and

assessment tools (not shown).

The customer dashboard 602a is identified by a customer dashboard icon 622 and a customer dashboard title 624. A customer data drop-down menu 634 enables the worker to access more specific customer data such as customer reports. The customer dashboard 602a also includes a list of customers identified by icon 626 and name 628 that are associated with the worker. Next to the customer's name 628 could be other identifying information, such as a customer rating or date the customer became associated with the organization. Under each name 628 is a list 630 of information related to the customer. The list 630 could be organized as a list of folders 632 identifying matters and containing documents or links relating to the customer such as contracting information 632a, proposal information 632b, and finance information 632c. Alternatively or additionally, the list 630 could list key events for the worker as relating to that customer. The key events can include upcoming meetings, status of work being done for the customer, and special notes such as marketing initiatives or organization-wide concerns such as customer retention. An icon may be next to one or more of the key events flagging that event to highlight the key event's importance.

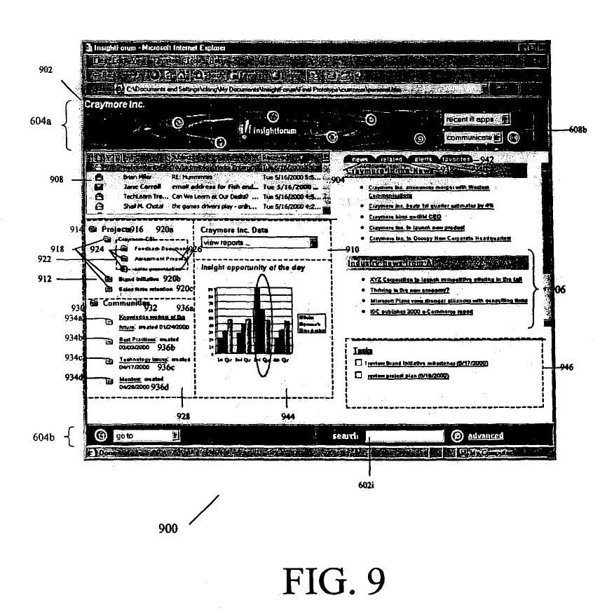

When the worker clicks on the customer's name 628, a customer screen 900, shown in FIG. 9, opens. The customer screen 900 is customer-specific, identifying the customer by name 902, and containing links and information pertaining to the customer and all projects and sub-projects that pertain to this customer account. The other identifying information included on the initial/overview screen 600 could also appear on the customer screen 900. Essentially, the customer screen 900 provides a way for people at the customer interface to network with project teams, communities, or discussion threads that deal with (or have had experience with) issues similar to what the people currently face with this customer.

The data included on and the features and lists accessible from the customer screen 900 are all specific to the customer. This tailoring can be done on all screens the worker may access. Filters, agents, and profiling protocols used in formulating the data included on the customer screen 900 (and on other screens described below) allow the electronic infrastructure to dynamically change in relation to preferences, use, and context. By tailoring the information displayed to the worker to information specific to the customer and to the worker, the worker can easily access customer data and keep well-informed as to all matters related to the client. For example, a news section 904 can contain external news feeds of up-to-date news articles, press releases, and bulletins relating to the customer, including the customer's products, as well as news related to the customer's industry, including the customer's competitors, in an industry news section 906. The email section 908 can filter the worker's list of emails to only include emails related to the customer, although the worker can switch views to access all of his or her email in the email section 908. From the customer screen 900, the search engine 602i enables a worker to search for project teams, communities, stories, or discussion threads that deal with the issue he or she faces with the customer. If none exist, the worker can set up a team, community, and/or discussion thread, and invite other workers to contribute to the resolution of the situation. This searching and setting up is discussed further below.

A customer view (that is, how the data is organized and displayed on the customer screen 900) is defined by manual intervention by an administrator (typically a project leader). In defining a customer view, additional information such as business issues involved with the customer, skills required to work with the customer, and any associated problems/solutions with the customer is input through a wizard (as described below). As time passes, the creation of the customer view becomes less manual, with additional information coming from the results of the customer team's work. When a worker is added to this customer team, the customer is listed on the worker's initial/overview screen in the customer dashboard 602a.

If a worker is assigned to a customer, he or she has access to all information (limited in some instances by the worker's access rights) on the customer's customer screen 900. If the worker is not assigned to this customer, non-security-sensitive information can be accessed on a read-only basis.

Components of the customer screen 900 may include:

customer information, for example, data accessible through a customer data drop-down menu 910 such as documents (or links to documents) relating to customer reports, benefits, business, company values, personnel (internal and/or external), quarterly tracking information, and actions;

projects list 912 identified by a projects icon 914 and by name 916 (each project identified by a project icon 918 and a project name 920 and filtered for projects related to this customer);

sub-projects 922 (each sub-project identified by a sub-project icon 924 and a sub-project name 926 and listed below their parent project and filtered for sub-projects associated with projects related to this customer);

communities 928 identified by a communities icon 930 and by name 932 (each entry identified by a community icon 934 and by name 936 filtered for workers, teams, sub-teams, related teams, and communities associated with this customer);

email/scheduler applications 908 (filtered for email and scheduled items relevant to this customer);

threaded discussions (not shown, but accessible from the communicate menu 608b) (filtered for discussions relevant to this customer or with team members);

sidebars 604a-b;

news 904 (filtered for news related to this customer);

related clients and projects 938 (other, non-confidential customers and projects of the organization that match any events/items/issues/solutions associated with the customer);

alerts/updates/notifications 940 (filtered for alerts related to this customer, such as personnel or departmental alerts and the most recent additions to the electronic infrastructure 500 relating to this customer);

favorites 942 (filtered to reflect this customer);

opportunities (for example, an opportunity of the day 944);

measurement data (not shown) (for example, CRM data and team/customer satisfaction data;

project management information (for example, task 946);

search engine 602i; and

instant messaging (not shown, but accessible from the communicate menu 608b) (filtered for team members assigned to this customer).

Returning to FIG. 6, the project dashboard 602b is identified by a project dashboard icon 638 and a project dashboard title 640 and includes a list of projects, each project identified by a project icon 642 and a project title 644. Project titles 644 identify an issue or organization-wide problem, not one particular customer. For example, a title could be “product development” or “customer retention.” Under each title 644 is a list (not shown) of key events associated with that project.

When a worker invokes a link displayed in the project dashboard by clicking on a project title 644, a project screen (not shown) is displayed. The project screen is project-specific, identifying the project by name and containing links and information pertaining to a particular project and all projects/sub-projects that pertain to this project. The project screen is organized and functions similar to the customer screen 900.

Like the customer view, a project view is defined by a manual intervention by an administrator. In defining a project view, additional information such as business issues involved with the customer, skills required, and any associated problems/solutions is input through a wizard (as described below). As time passes, the creation of the project view becomes less manual, with additional information coming from the results of the project team's work. As workers are added to this project team, the project is listed on that worker's initial/overview screen in the project dashboard. Additionally, customer information related to the projects is derived from the organization's CRM and ERP systems. This data, combined with the organization's business rules (incorporated in the CRM system), flags certain customer accounts for specific action in certain projects/initiatives. When a customer is thus flagged and included in a project, associated workers also become a part of the project team.

If a worker is assigned to a project, like being assigned to a customer, he or she has access to all information (limited in some instances by the worker's access rights) on the project's project screen. If the worker is not assigned to this project, non-security-sensitive information can be accessed on a read-only basis.

The project screen has the same capabilities and functionality as the customer screen 900 of FIG. 9 with a few differences. The project screen is not associated with a particular customer, so the CRM data is roll-up and management-type data. Also, the related customers and projects are likely to be manually added as a result of assigning the project-focus to a particular customer, i.e., a project that is focusing on customer retention and a customer that has been flagged as a target customer for retention. This cross-referencing results in cross-access to information within communities, certain applications, and the game environment, inclusion of subject matter experts (SMEs) in the customer community, and likely inclusion of the customer project leader in the project community.

The components of the project screen are also similar to the customer screen 900 and may include:

project information;

customers list (filtered for customers related to this project);

sub-project list (filtered for sub-projects associated with this project);

communities (filtered for workers, teams, sub-teams, related teams, and communities associated with this project);

email/scheduler applications (filtered for email and scheduled items relevant to this project);

threaded discussions (filtered for discussions relevant to this project);

sidebars;

news (filtered for news related to this project);

related clients and projects 938 (other, non-confidential customers and projects of the organization that match any events/items/issues/solutions associated with the project);

alerts/updates/notifications (filtered for alerts related to this project, such as personnel or departmental alerts and the most recent additions to the electronic infrastructure 500 relating to this project);

favorites 942 (filtered to reflect this project);

opportunities (for example, an opportunity of the day 944);

measurement data, for example, CRM data and team/customer satisfaction data;

project management information, for example, tasks;

search engine; and

instant messaging 216 (with team members assigned to this project).

The sub-projects list is identified by a sub-project icon and a sub-project dashboard title and includes a list of sub-projects identified by a sub-project title.

Clicking on a sub-project title opens a sub-project screen (not shown). The sub-project screen 280 is identical to the project screen, but the data and applications on the sub-project screen are specific to the goals of the sub-project, not the entire project or customer work. The sub-project screen includes a way back to the main project screen or to a related customer screen, as well as a team list (instant messaging) and team discussion threads that are cross sub-project. The sub-project screen is sub-project-specific. All information on the sub-project screen is displayed there because it pertains to this sub-project. The worker has access to this page because he or she is part of this sub-project team.

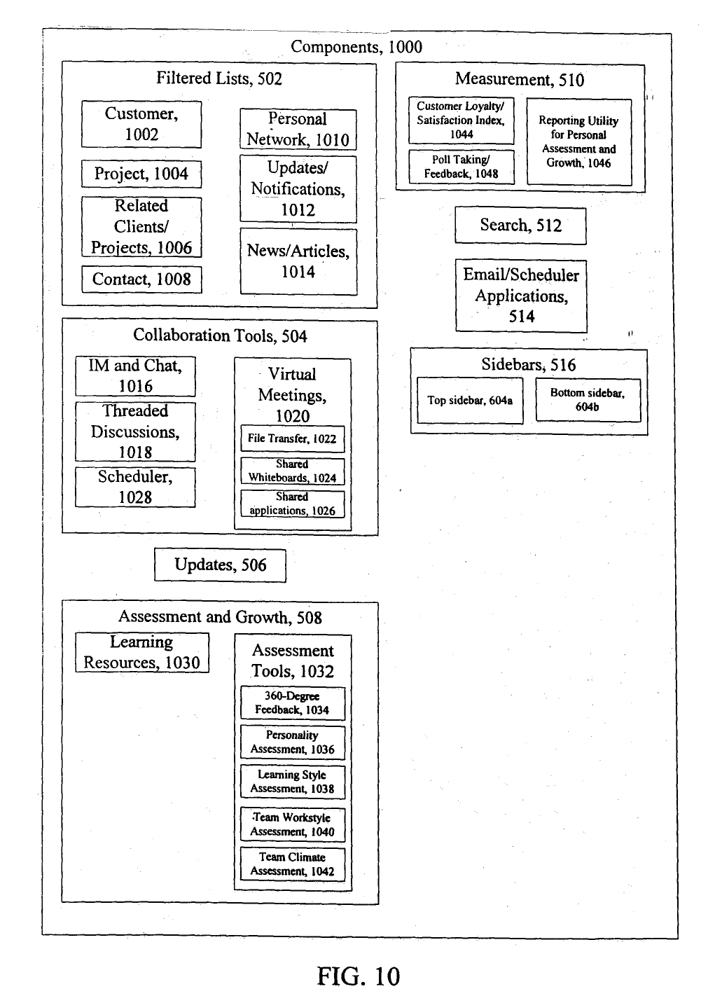

Referring to FIG. 10 to further describe components 1000 in the electronic infrastructure 500 (as shown in FIG. 5) that are accessible through the initial/overview, customer, project, and sub-project screens, the lists 1000 can include filtered lists 502, collaboration tools 504, updates 506, assessment and growth tools 508, measurement lists 510, a search engine 512, email/scheduler applications 514, and sidebars 516. Each one of these list types is described in turn.

The electronic infrastructure 500 uses the filtered lists 502 to display data on a worker's initial/overview, customer, project, and sub-project screens, the data being filtered based on the worker's access level and the screen from which the list was accessed. Examples of the filtered lists 502, each described below in turn, include a customer list 1002, a project list 1004, a related clients/projects list 1006, a contacts list 1008, a personal network list 1010, an alerts/updates/notifications list 1012, and a news/articles 1014 list.

The customer list 1002, e.g., the customer dashboard 602a of FIG. 6, includes a listing of the customers that the worker has been assigned to, viewed within the parameters of the currently viewed screen and drawn from the organization database 548. If the worker is viewing the initial/overview screen, he or she sees a list of his or her assigned customers. If the worker is viewing the customer screen, he or she sees currently selected customer information that he or she has access rights to. If the worker is viewing the project screen, the list of customers is filtered to show only those customers that are included in (targeted by) the currently viewed project. The customer list 1002 is expandable/collapsible to help manage screen space.

The project list 1004, e.g., the project dashboard 602b (FIG. 6), 912 (FIG. 9), includes the projects/initiatives that involve the worker. In general, the worker sees a listing of the projects he or she has been assigned to, viewed within the parameters of the currently viewed screen as described above with reference to the customer list 1002. The project list 1004 is expandable/collapsible to help manage screen space.

The related clients/projects list 1006, e.g., the related clients/projects list 938 (FIG. 9), 602d (FIG. 6), includes a listing of customer accounts and projects that have some cross-reference connection with the worker or the customer account or project on the currently viewed screen. Essentially, the related clients/projects list 1006 further filters the information in the customer list 1002 and the project list 1004 based on data fields that show common relationships between customers and projects/sub-projects. CRM industry data and problem/solution data from the engine application can provide the data for filtering. Clicking on the name of a customer or a project in the related clients/projects list 1006 takes the worker to the corresponding customer or project screen. Only those customers/projects that are not restricted (filtered) in some way are accessible. Customers/projects that are available for reference appear with a link leading to a blank email message from the worker to the customer/project leader that the worker can compose and send. Customers/projects that are blocked from view entirely do not show up at all.

The contact list 1008 includes all workers in the organization database 548 (in FIG. 5) and is filtered to show only the workers who are associated with the worker or the currently viewed customer or project. Contact data can be drawn from multiple sources, including HRIS data, CRM data, and SMEs included in the electronic infrastructure database 560 (in FIG. 5) and organization-added SMEs, consultants, and resources. The contact list 1008 may be filtered based on the screen it is accessed from as described above.

The worker at any time has the ability to access the organization's entire-contact database (included in the organization database 548 shown in FIG. 5) and the worker's personal network 1010 (described below). Listed SMEs might be contacted by the worker for valuable information, knowledge or guidance in completing projects or finding solutions. The contact list 1008 is also searchable (name or skill-based search). The contact list 1008 is used for/available for a variety of other lists and applications such as instant messaging, discussion threads, community applications, game applications, team contact and profile-information, and virtual meetings.

In addition to the contact list 1008, the worker may have other (personal) contacts that are outside any corporate, customer, or project context. The contact information for these individuals is private (not accessible by other workers) but easily accessible by the worker from any screen via the personal network list 1010. The personal contacts may include individuals outside the organization's list of contacts and/or it may include worker-selected contacts from the following lists:

team members;

communities;

mentors/coaches;

SMEs; and

other organization or customer employees.

The worker can create a personal network list 1010, add contact information, edit the contact information, and sort and view the personal network list 1010 by category, customer or project. Clicking on the name of a person on the personal network list 1010 gives the worker an opportunity to interact with that person via one of several choices (applications) including:

email;

instant messaging;

chat;

virtual meeting room; and

game session.

The alerts/updates/notifications list 1012, e.g., the alerts/updates/notifications list 602e (FIG. 6), 940 (FIG. 9) includes headlines/titles of changes that have taken (or are taking) place in projects, communities, customers, games, and other applications that pertain to the worker, customer, or project (depending on the currently viewed screen). The data for these headlines comes from the electronic infrastructure database 560 (in FIG. 5)—the database that stores the results of all activities in the collaboration and insight applications. The data schema includes a method for tagging the stored results according to their relation to workers, customers and projects/sub-projects. The alerts/updates/notifications list 1012, filtered to show only those updates and notifications pertaining to the currently viewed screen, is updated (refreshed) regularly throughout the day at a time interval determined by the worker in his or her preference settings. The alerts/updates/notifications list 1012 serves as a “push” to alert the worker to important changes within his or her groups. Clicking on a displayed headline takes the worker to the corresponding customer, project, community or game. The alerts/updates/notifications list 1012 also enables the worker to push/send an email to other workers/contacts at the discretion/setup of the worker. The alerts/updates/notifications list 1012 does not include every action in the system. Workers receive high level alerts/updates/notifications only, such as:

added to a team (customer/project);

new activity launched within an application; and

team and/or company news “posting.”

Instead of receiving alerts/updates/notifications in real-time, the worker may choose to have a digest of the day's alerts/updates/notifications sent to him or her via email on a daily basis.

The news/articles list 1014, e.g., the news list 602c (FIG. 6), 904 (FIG. 9), provides headlines that contain articles affecting the customers or projects involving the worker. Each entry in the list includes a headline along with a brief synopsis (or first paragraph) of the article. Clicking on a headline takes the worker to a page displaying the full article. The worker may also be able to filter news according to industry, competitors, subject matter, etc. The headlines might come from outside data sources 566 (in FIG. 5) or from the organization's administration.

Because the headlines may not always come from external feeds, there is a need to have an application to post news either within a customer/project view or for company-wide view (with proper access). To enable client administration to post in-house news, an online mechanism for posting news articles and announcements provides a way to tag articles in such a manner that enables the filters for the news/articles list 1014 to more easily display articles associated with specific projects, customers, etc. This news-posting application acts similar to a bulletin board, but without discussion thread capability. Worker-posted links include the headline and a field for posting a brief explanation of the link and why it is important.

Another component of the electronic infrastructure 500, the collaboration tools 504, enable workers to use the information obtained through the filtered lists 502. Examples of collaboration tools, each explained below in turn, include instant messaging (IM) and chat 1016, threaded discussions 1018, virtual meetings 1020, and scheduler 1028. Some or all of the collaboration tools are accessible via the communicate menu 608b on the top sidebar 604a (FIG. 6). The collaboration tools 504 are applications that provide workers with the ability to connect synchronously and asynchronously with peers and mentors while working with other applications, e.g., the game environment, regarding practice areas, issue areas, and customers and to discuss, brainstorm, troubleshoot, and solve problems. Communications through the collaboration tools 504 are secure and are captured/stored for future reference/posterity.

One collaboration tool 504 includes IM and chat 1016. The IM application enables communication between all connected workers, including:

people on the worker's contact list 1008;

team members (filtered by currently viewed customer/project);

community members (filtered by currently viewed customer/project);

mentors and coaches;

SMEs and outside experts; and

people on the worker's personal network 1010.

The worker can contact any individual included in his or her personal network list 1010 and can add new members to that network 1010.

The IM application 1016 may include:

one-on-one chat;

status notification (online, available, busy, etc.);

conference (multi-person chat);

searching capabilities (by name, expertise, etc.);

voice chat: the ability to hold hands-free conversations, allowing workers to talk and listen at the same time with multiple workers;

the ability to send a file directly to the participants of a chat session (file sharing);

the ability to save and retrieve transcripts, possibly categorized by customer, context, project, etc.; and

the ability to add members to the worker's personal network 1010, mentors and coaches, and SME lists.

Accessing the IM and chat tool 1016 opens up an IM or chat screen (not shown). Providing tabs at the bottom of the IM or chat screen can enable the worker to quickly switch between news updates, links, lists of contacts, email, etc. Alerting the worker to new email while using IM or chat and using expandable/collapsible lists of contacts in multiple categories may also help the worker maneuver through IM and chats. Workers may choose to minimize some/all incoming messages to the taskbar so that the worker can view them whenever he or she wants.

Another collaboration tool 504 includes threaded discussions 1018. The discussion threads that the worker sees on the menu are based on the worker's access rights, project/team affiliation, assigned customers, communities, etc. The threads seen are also filtered based on the currently-viewed customer, project, or sub-project. Threads do not have to be project or customer specific, but can be set up between workers/contacts across the organization. Clicking on the title of a discussion thread takes the worker to that forum. The threaded discussion application 1018 can include the following capabilities:

create a new forum;

post a topic;

reply to topics/reply;

attach referential documents/links;

invite participants;

summarize (rise-above) posting;

close forum/thread;

save forum/thread;

delete forum/thread;

search and list by topic, author, date, keyword, etc.; and

author information to enable the viewing worker to directly contact the author via email, instant message, phone, etc.

Virtual meetings 1020 are another collaboration tool 504. Virtual meetings 1020 enable workers invited to a virtual meeting to communicate in writing or via audio using IM and chat and to hold one-on-one side conversations during the course of the meeting. When multiple workers are meeting together, it is assumed that one worker (at a time) is in charge of the meeting. Workers can use a “hand-raising” feature to request the worker in charge for a turn to speak or demonstrate. The virtual meeting application 1020 also can provide the ability to poll meeting participants. Meeting notes are generated in real time as the meeting progresses. Items and issues flagged for later action can be recorded as they are discussed and then distributed/stored at the end of the meeting.

While involved in a virtual meeting, workers can use other lists and applications to interact with the meeting participants. Workers can transfer files directly to meeting participants using a file transfer application 1022. Additionally, shared whiteboards 1024 allow workers to draw, type, or cut and paste text, graphics or other media to be viewed by all meeting participants. Shared applications 1026 enable multiple workers to view a document created by a desktop application, such as a word processing program. One worker can control a shared whiteboard 1024 and/or a shared application 1026, or control can be shared between workers, passed to another worker, or relinquished to multiple workers.

A scheduler application tool 1028 enables workers to schedule meetings or events for themselves, teams, communities, etc. using electronic invitations. Invited participants can accept/reject the invitation using the scheduler. The scheduler 1028 could be the (filtered) calendar functionality included in a desktop application or be a scheduler built into the virtual meeting or IM application. The scheduler 1028 can look across personal calendars to determine when all proposed meeting or event participants have available time. Scheduled workers can view the subject matter of the meeting or event, the method of the meeting or event (virtual meeting, chat, face-to-face, etc.), and any agenda items. All participants can also view the agenda before the meeting and add/suggest new items. The scheduler 1028 can alert workers before meetings or events on a worker-defined time frame. The scheduler 1028 can also include task features that let workers view a task list including a task, date due, date started, status, notes, related project, etc. and receive task reminders.

Alerts/updates/notifications 506, e.g., the alerts/updates/notifications list 602e (FIG. 6), 940 (FIG. 9), is another list included in the electronic infrastructure 500. The alerts/updates/notifications list 506 includes alerts/updates/notifications from activities, news feeds, document postings, etc. generated by applications and fed to the initial/overview, customer, and project screens and filtered according to the customer/project being viewed on the current screen. Activity/data generated through the various communication tools and applications trigger “headlines” and “blurbs” that appear in the alerts/updates/notifications section of the screens, filtered by the particular screen that the worker is viewing. A worker could choose to have a daily digest of activities related to his or her customers and projects sent to him or her via email. The application that generated the alert/update/notification may also be able to generate an email distribution list from the worker's personal network, filtered by the particular screen or activity that the worker is targeting.

Assessment and growth (exchange) tools 508 allow a worker to monitor his or her professional growth and, with mentor/management assistance, determine learning tracks that are necessary for career development. The primary assessment and growth tools 508 include learning resources 1030 and assessment tools 1032.

Workers can have access to formal learning resources 1030, e.g., resources from the organization's corporate training department or from outside vendors. “Traditional” learning tools can be incorporated into the learning resources 1030. The learning resources 1030 may also be catalogued so that they can be linked to worker-assessment tools/reports. The worker's use of the learning resources 1030 may also or instead be reported out so that the organization can demonstrate ROI, personal improvement, etc. in its workers.

The assessment tools 1032 include electronic, survey-based questioning of workers to evaluate various aspects of the worker, other workers, and the organization. The workers can electronically receive the results of the surveys from a reporting utility for personal assessment and growth (described further below) that can point the workers to learning tools for improvement in specific areas. The assessment tools 1032 include 360-degree feedback 1034, personality assessment 1036, learning style assessment 1038, team workstyle assessment 1040, and team climate assessment 1042.

The 360-degree feedback 1034 includes sending individual and team development surveys to multiple workers who fill out the survey and send it back. The 360-degree feedback 1034 implements a developmental cycle that helps performers (here, organizations):

target specific areas for performance improvement based on comprehensive 360-degree feedback;

receive online and/or personal coaching to develop an action plan for improvement utilizing coaching tactics based on the best practices of others;

get access to the specific learning resources that can help improve performance in the areas targeted for improvement; and

apply new learning to the next opportunity to demonstrate improved performance. To accomplish the developmental cycle, the 360-degree feedback 1034 can be implemented with a system such as Performance Compass™.

A developmental cycle that links job performance goals to development activities starts the organization off on their development journey by documenting job goals and competencies required for success before moving into assessment of feedback. Using the 360-degree feedback 1034, the organization can:

review job performance against goals;

use confidential results from feedback reports in its performance appraisal discussions;

include measures of success and milestones in action plans and make adjustments as necessary;

support recognition and organizational learning by submitting personal tactics; and

summarize completed developmental activities.

Thus, performance is about both immediate improvements based in feedback, as well as longer-term development planning.

Implementing the development cycle in the electronic infrastructure 500 could benefit the organization in a number of ways. First, the cycle creates tremendous focus and motivation by directly linking feedback with coaching and learning to drive improved performance. The second factor is the speed at which improved performance can be applied to the job. The organization can receive feedback, get access to online or personal coaching, and get access to the learning resources to help support performance improvement around a specific competency-all in real time. Finally, the collective organizational impact derived from making it available to a critical mass of managers and employees is key; this is organizational learning in action.

The personality assessment tool 1036 includes sending a personality survey, e.g., Myers-Briggs, to multiple workers who fill out the survey and send it back. The learning style assessment tool 1038 includes sending a learning style survey to multiple workers who fill out the survey and send it back. The results of the personality assessment and learning style assessment surveys provide the worker with a description of his or her personality and learning style. The information allows the worker to better understand the approaches he or she is likely to use in approaching new situations, in learning new materials, and in working with others. The information is also useful to team leaders trying to figure out how to work with others and how to combine/divide the team into sub-teams for various tasks.

The team workstyle assessment tool 1040 and the team climate assessment tool 1042 include electronically sending a team workstyle and a team climate survey respectively to multiple workers who fill out the survey and send it back. The team assessment tools 1040, 1042 can be particularly useful to team leaders trying to figure out how to work with others and how to combine the team into sub-teams for various tasks.

The measurement lists 510, along with CRM measurement, can give an analytical picture of progress against goals, level of insight/solution generation, issue resolution, etc. A customer loyalty/satisfaction index 1044 can use CRM data to enable workers (from within a project or customer team) to rate/measure customer loyalty for a specific customer. A reporting utility for personal assessment and growth 1046 can report to worker(s) the results of assessment surveys. The reporting utility 1046 can:

tabulate results of survey questions;

rate/assess the worker in categories;

report on the number/percentage of surveys/participants that have been tabulated/completed;

determine how much more time is left until all surveys should be returned;

report out (to administration) who participated/didn't participate in the surveys; and

determine how to apply the results to affect game personas, game environment, and game scenarios.

A poll-taking/feedback application 1048 can allow a worker to easily include a poll question(s) within a document/activity/posting, etc. The poll results can be tabulated, made available for immediate viewing, and saved for future reference from searches and other applications.

The search engine 512, e.g., the search engine 602i on the bottom sidebar 604b (FIG. 6), allows a worker to search by keyword, worker name, project or customer name, or the full text of data from multiple sources. The search engine 512 involves a “smart” search that allows context-sensitive and pattern results, e.g., the Autonomy™ search engine. Areas that may be searched, subject to access level, include:

shared corporate directories;

worker profiles;

electronic infrastructure content;

discussion forums;

stored articles, postings, etc.;

organization databases; and

CRM/HRIS/ERP data.

Default filtering searches only for those items pertaining to the customer/project on the currently viewed screen. The worker has the ability, however, to alter the search parameters, enabling a full search of all available sources of information. Keywords can come from meta-data, indexes, or from text pattern matching and include usage ratings, etc. to bring most commonly used and highest rated to the top.

The email list 514, e.g., the email list 602h (FIG. 6), 908 (FIG. 9), incorporates a view of the worker's email application on the worker's screen. This includes access to the worker's email message folders, scheduling and task applications, contact database, etc. The email list 514 uses a screen-specific filter to only show information pertaining to the current screen view. Default settings initially provide for which email applications are displayed on the worker's screens. These settings may be “locked in” or may be altered by each worker to offer a highly personalized view.

The sidebars list 516 includes sidebars that provide shortcuts/links to applications that the worker may find useful in his or her daily work and interactions with others. Two sidebars, the top sidebar 604a and the bottom sidebar 604b are described above (FIG. 6).

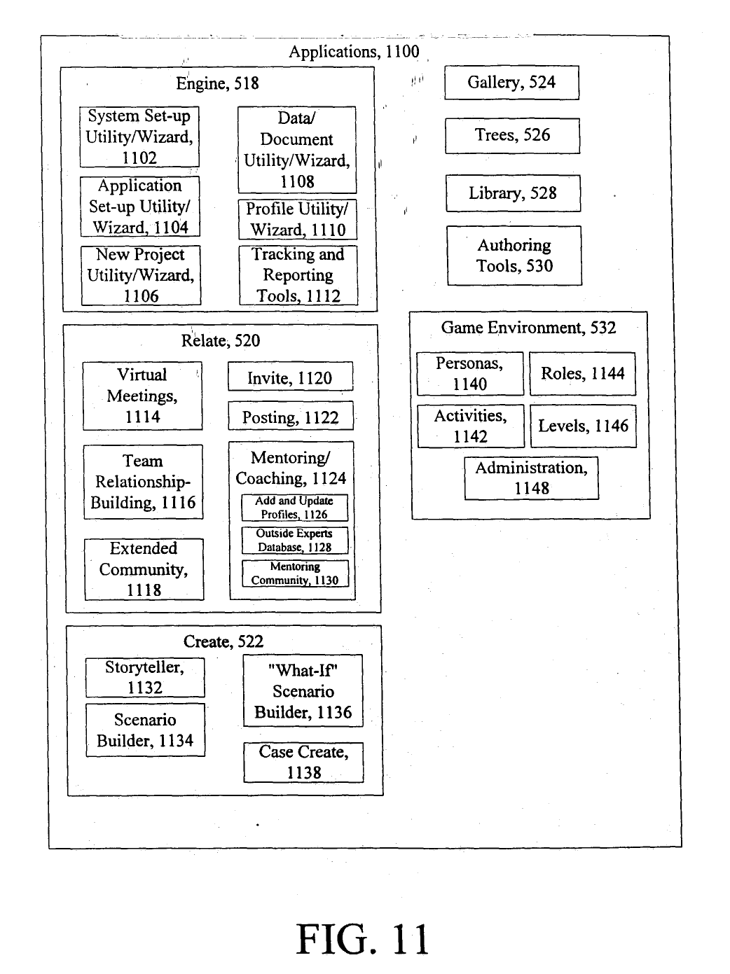

Referring to FIG. 11, the electronic infrastructure 500 (shown in FIG. 5) also includes a number of high-level applications 1100, each described in turn below: an engine application 518, a relate application 520, a create application 522, a gallery application 524, a tree application 526, a library application 528, authoring tools 530, and a game environment 532. Each application 518-532 has multiple views. The view seen depends on the screen from which the worker accesses the application 518-532.

The engine 518 acts, as described above, as the electronic infrastructure's primary administration/configuration tool. Eventually, the setup of new projects/customers requires a minimum amount of administrative tasks and is more a derivative of actions of teams of workers as processed by the engine 518. In addition, documents, etc. inherit as much meta-data from normal application usage as possible and are searchable based on natural language pattern matching to minimize data-input requirements. The engine 518 also can read a worker's access rights/level, thereby limiting his or her ability to change, add, or view data through the electronic interface. For example, certain action flags are automatically set on individual customer accounts because of CRM data, but flags may be manually set by individuals whose access rights are at a high enough level. Certain screens can also display different CRM or electronic interface data based on a worker's access settings.

The engine 518 includes a number of utilities (“wizards”) that execute the electronic infrastructure's administration/configuration tasks. An administrator of the electronic infrastructure 500 can use these wizards to access data, documents, and worker profiles and to set up, change, and maintain the electronic infrastructure 500. Connections to the organization database 548 and the electronic infrastructure database 560 can be set and/or changed using a system set-up wizard 1102 that walks the administrator through the necessary steps. An application set-up wizard 1104 allows the administrator to set up, change, and maintain the electronic infrastructure 500. A new project wizard 1106 enables workers having a minimum access level to set up and modify projects. The new project wizard 1106 walks the worker through the necessary set-up steps in creating a project/sub-project and selecting workers to add/remove to that project. A data/document wizard 1108 permits workers to post new data/articles/document-s/news items to the electronic infrastructure 500 based on access rights/level. These new items may be added to enhance knowledge or to influence views. Although basic information regarding workers usually comes from HRIS data, the administrator can edit or set profiles through a profile wizard 1110. The administrator can also create tracking and reporting tools 1112 to track and report worker usage of, progress (growth) from and participation in the lists and applications included in the electronic infrastructure 500.

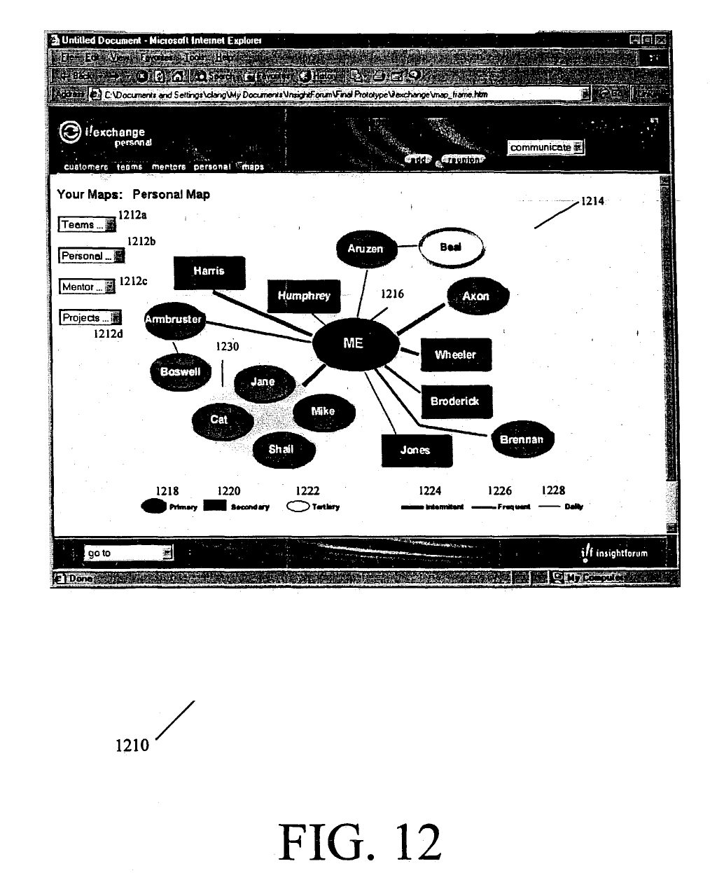

Another high-level application, the relate (exchange) application 520, includes a number of applications to encourage and facilitate communication among workers. Views of the relate application 520 can include a customer view 12, a teams view, a mentors view, a personal view, and a maps view. As shown in FIG. 12, each of these views may be accessed by clicking on a corresponding tab 1200-1208 while in the relate application 520. Customers of the organization can use the relate application 520 to be integrated into a team and participate in decision-making and strategies. The organization can choose, however, to limit the amount of internal data that the customers may view while using the relate application 520.

The relate application 520 includes a virtual meeting application 1114, discussed above.

Additionally, the relate application 520 includes a team relationship-building application 1116 as shown on a maps view 1210 in FIG. 12. The team relationship-building application 1116 may include the gallery application 524 (described below) and/or lists accessible by menus 1212a-d such as teams 1212a, personal 1212b, mentors 1212c, projects 1212d, consultants (not shown), and SMEs (not shown). The maps view 1210 displays in a map 1214 where the worker (represented by a “ME” block 1216) fits into the organization's network structure. The worker may use the maps view 1210 to see how the organization is structured, to see how the organizations' workers interact, to determine what particular worker's are interested in and are working on, to pull together groups of people with similar interests, and to help new workers assimilate into the organization. The map 1214 is generated based on data included in databases accessible by the electronic infrastructure 500, e.g., the organization database 548, and information entered by the worker. People on the map 1214 are represented by a block indicating their contact level with the worker: a dark oval 1218 for primary contacts, a rectangle 1220 for secondary contacts, and a light oval 1222 for tertiary contacts. The connection lines between blocks indicate the frequency of contact between the worker and that person: an extra-thick line 1224 for intermittent contact, a thick line 1226 for frequent contact, and a thin line 1228 for daily contact. Teams may be indicated by a shaded shape 1230 disposed below the team members' blocks.

An extended community application 1118 included in the relate application 520 allows workers to invite and to participate in projects with other workers (internal or external to the organization) who can add value to a project. Participation is by invitation only. Workers need a way to find appropriate workers to invite to the project. Workers may use an invite tool 1120 to search contact lists or other organization lists for people with a certain expertise, to post a message to the organization calling for people with a certain expertise, or to ask particular individuals to join the project.

The relate application 520 also allows workers to post an article, document, link, etc. for group viewing using a general postings application 1122. The view of the posted item is determined by worker access rights and the currently viewed screen. The posting tool 1122 allows the worker posting the item to determine on what date the item is available/visible to other workers and on what date the item will be archived (removed from view, yet still available by search). Once posted, the item shows up on posting lists/news/updates by title and brief description. When the worker clicks on the title, he or she is taken to the full document/content.

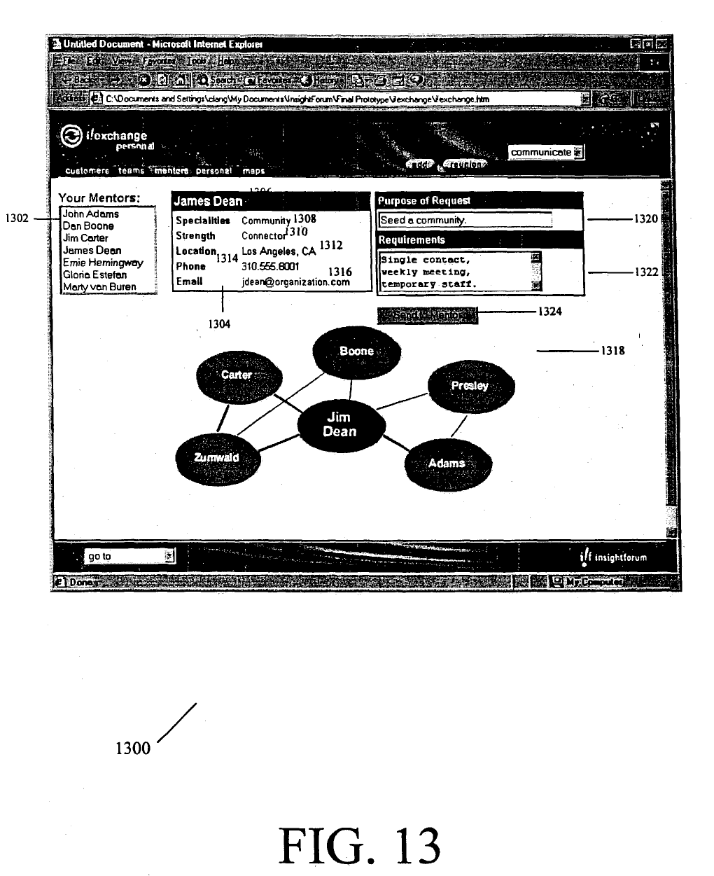

The relate application 520 also includes a mentoring/coaching application 1124 as shown on a mentors view 1300 in FIG. 13. The mentors view 1300 includes the same tabs 1200-1208 as on the maps view 1210 (and other views associated with the relate application 520). With the mentoring/coaching application 1124, workers can add and update the profiles of workers 1126 within the organization resources to identify individuals who are SMEs or have experience or interest in subjects or activities that would relate to a specific project or customer situation. Each worker's mentors (coaches) are listed in a mentors list window 1302. By clicking on a mentor's name in the mentors list window 1304, information on that mentor appears in a mentor information window. This information can include the mentor's name 1306, specialties 1308, strengths 1310, location 1312, phone number 1314, and email address 1316. Clicking on a mentor's name can also bring up a map 1318 showing where that mentor (represented by a center, darkened block 1320) fits into the organization's network structure.

Workers may be indexed as mentors based on the content of documents they post to the corporate network drives (for example), thereby offering a worker a way to find individuals who might give assistance in finding a solution. The mentoring/coaching application 1124 can also enter outside experts into a database of experts 1128 or permit database augmentation by individual entry.

A private one-on-one or group mentoring community 1130 may also be included in the mentoring/coaching application 1124. An individual or team can set up a private community 1130 where a worker (mentor or SME) can communicate and post documents/discussions with the intent to teach/coach in skills, etc. The worker(s) can enter a communications request in a request window 1320 and a brief description of the request in a communications requirements window 1322. The worker can send the request and the description to the mentor by clicking on a send button 1324. Having private communities 1130 implies a need for “private rooms” for one-on-one or group-specific community and/or game activities.

Another high-level application is a create application 522. The create application 522 includes applications that let workers create knowledge generation objects to be used by others. Other workers can learn from the creator, can add to the objects, share and reflect on experiences, and gain new insight. Stored results become intellectual capital (knowledge objects, demonstrations, etc.). The create applications are interactive, and creators can build on others' work and/or capture their own insights.

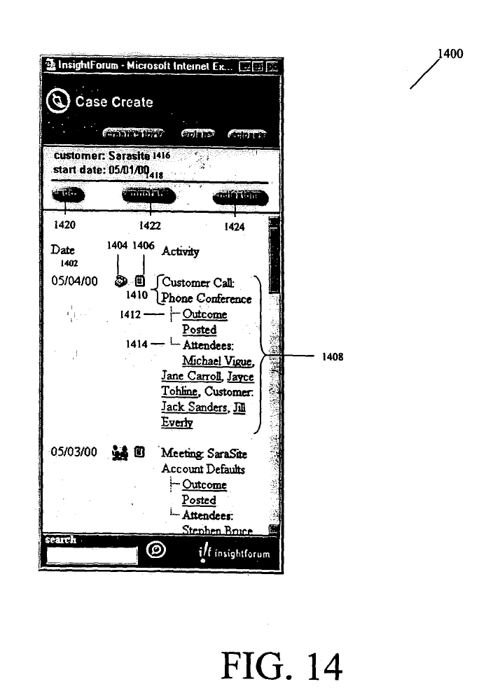

One create application 522 includes a case create application 1138, shown in FIG. 14 on a case create screen 1400. The case create application 1138 records facts and logs the activities of a worker/group/team on an account from the account's inception. The case create screen 1400 includes a name 1416 of the customer (or project) and its inception date 1418. Each activity is identified by a date 1402, an activity icon 1404 that identifies the type of activity, a document icon 1406 that links to the activity, and a description 1408 of the activity including activity type 1410, a posted outcome 1412, and workers involved (attendees) 1414.

A number of buttons on the case create screen 1400 enable the worker to manipulate the data on the case create screen 1400 or to access another facet of the create application 522. Clicking on an add button 1420 enables the worker to create a new activity. Clicking on an annotate button 1422 allows the worker to edit an entry for an activity. Clicking on a close button 1424 closes the case create screen 1400.

By viewing the data on the case create screen 1400, a worker can see the story of an account: the behavior of workers involved with a particular customer or project, what tactics work and what tactics do not work, and patterns within one or more accounts. Also using the case create screen 1400, a worker can plan the future of an account.

Another create application 522, a storyteller (story creation) application 1132, walks (guides) a worker through the construction process of a document (story, proposal, meeting notice, meeting summary, etc.) using a storytelling template/creation process, enabling him or her to craft a story, not just write a boring blurb. The storyteller application 1132 helps the worker determine the type of story (i.e. a branch in the application) and find related stories based on characters (client, project team, etc.), topics, outcomes, objectives competencies, etc. The storyteller application 1132 is a visual tool that utilizes reusable, component-based construction. The outcome (document) is linear, but creation is non-linear, allowing the worker td put the components of a good story together, but not requiring him or her to fill-out forms that restrict creativity. The storyteller application 1132 may:

allow the worker to link to other stories;

give the ability to associate the story with content sources;

explore attitudes, feelings, and experiences based on a set of facts from different perspectives;

evaluate past actions to make more informed decisions in current, similar actions;

help the worker set characteristics such as atmosphere, background, sound, pictures, and characters; and

enable the worker to create dialogue, add a voice track, and personalize the story to the audience.

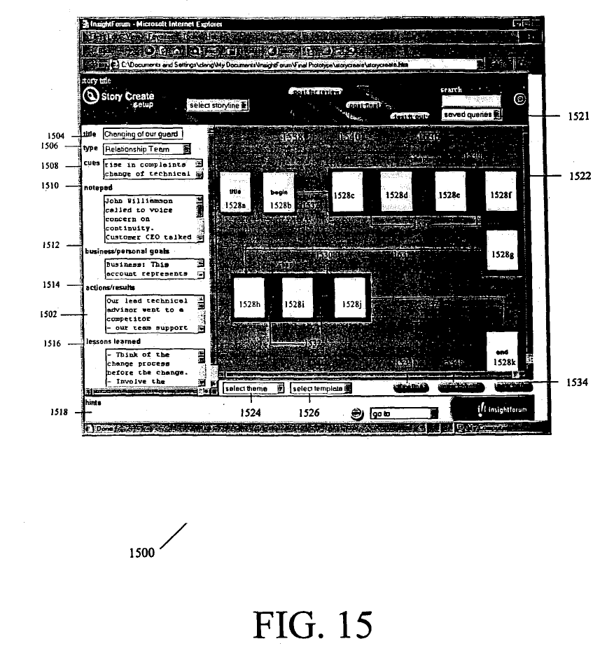

Referring to FIG. 15, a story create screen 1500 facilitates the creation of a story. Creating a story includes three aspects: developing a storyline, creating a setup, and finalizing the story. The worker may select an existing storyline from a drop-down storyline menu 1520 (which can become a story title 1504), access a saved story from a drop-down query menu 1521, or may develop a new storyline. Developing a new storyline includes providing brief written descriptions of the story that the worker wants to create in a story information window 1502. The story information window 1502 includes windows to develop the storyline including the story title 1504, a story type 1506, cues 1508, and a notepad 1510. The windows are initially blank, except for the story type 1506, for which the storytelling application 1132 may provide a list of choices in a drop-down menu, and for the notepad 1510, for which the worker may use a drop-down menu (not shown) to select notes from the titles stored in the gallery application 524. The cues window 1508 is a keywords section to be used to contain memory cues and facilitate pattern-matching between stories and storylines. The story information window 1502 also includes windows to setup the story including business/personal goals 1512, actions/results 1514, lessons learned 1516, and other facets of the worker's story that may be entered in a story layout window. The storytelling application 1132 may also provide one or more hints for developing the story in a hints window 1518. The contents of the hints window 1518 changes according to where the worker is in the create application 522. For example, when the worker accesses the story type drop-down menu, the hints window 1518 may provide information about the different types of stories and sample storylines. In addition, if the worker pulls down a story template drop-down menu 1526, the hints window 1518 may provide guidelines for the different kinds of templates.

Once the storyline is set, the worker can create the story in the story layout window 1522. The story layout window 1522 visually displays the story and utilizes reusable, component-based construction. When the worker first accesses the story layout window 1522, it is blank. The worker can build the story from scratch or can select a story theme from a story theme drop-down menu 1524 and/or select a story template from a story template drop-down menu 1526. The story theme drop-down menu 1524 provides a storyboard structure based on the type of story. The story template drop-down menu 1526 provides visual display characteristics such as graphics, sounds, buttons, palettes, backgrounds, and type styles. The story in the story layout window 1522 is displayed as pages 1528, like in a tangible, written story. An example of a story template is shown in FIG. 15 in the story layout window 1522. This story template includes a title page 1528a, an introduction (begin) page 1528b, a conclusion (end) page 1528k, and two chapters 1530a-b including five and three pages 1528c-g, 1528h-j respectively. A story can omit any of these elements or add additional elements such as an appendix or more chapters. The story order is indicated by directional arrows 1532.

Story creation buttons 1534 provide more story creation tools. A timeline button 1534a enables the worker to include links to a case create window (see FIG. 14), thereby creating a chronological order of major events (often the first step in page organization). A new chapter button 1534b creates a new chapter in the story layout window 1522, including any necessary directional arrows. A new page button 1532c creates a new page in the story layout window 1522.

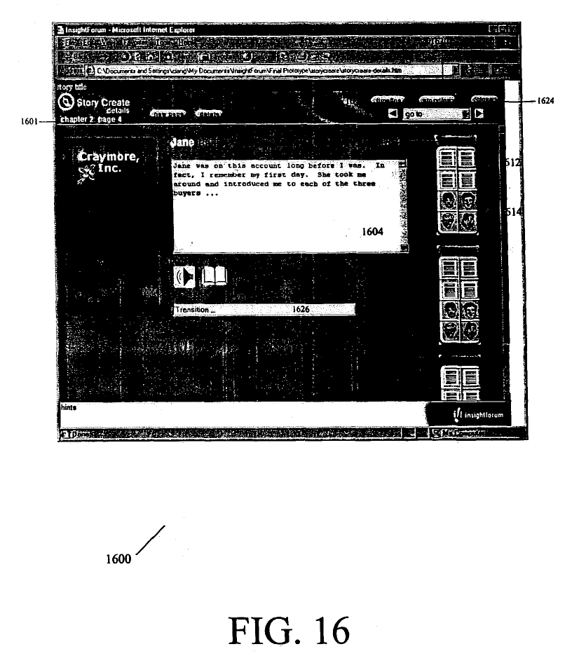

Clicking on a page 1528, e.g., the fourth page 1528f in the first chapter, brings up a story page (details) screen 1600 as shown in FIG. 16. The story page screen 1600 is where the worker gathers information and actually writes and views each page of the story. The story page screen 1600 identifies 1601 the page being viewed and includes a title 1602; here the title 1602 is the name of a person involved with the story, i.e., a “character” in the story. A dialogue window 1604 is where the worker can enter the text of the page. The text is like a notepad, usually describes the title 1602, e.g., a person's involvement in the story, events at a meeting, or proposals made in a memorandum. The worker can also click on a sound icon 1606 to add sounds to the page, e.g., the voice of the person named in the title 1602. The sound may play automatically upon opening the page or it may be played by clicking on the sound icon 1606 associated with that page. Similarly, clicking on a text icon 1608 allows the worker to add descriptive text to the page, e.g., a brief biography of the person named in the title 1602, and clicking on the text icon 1608 displays the text associated with that page. the worker may also access a transitions section 1626 to help create transitions between scenes and pages. The worker can pull down from a transitions palette (not shown) a list of sample transitions or select transitional elements such as text and graphics.

A palette window 1610 provides a document palette 1612, a character palette 1614, and a visual palette (not shown). The document palette 1612 provides reference materials (documents, files, etc.) for inclusion in the story as text or as links. The character palette 1614 allows the story to include freeform pictures, caricatures, or actual pictures of people (“characters”) involved in the story, also likely included in the dialogue window 1604. The visual palette contains models, graphics, pictures, etc. that are specific to the story. The items included on the visual palette are gathered or created by the worker. Items from the palettes can be dragged and dropped into the story. When information is gathered into a palette in the story creation process, the palette is available at any point in the story creation process.

Clicking on the begin page 1528b and/or the end page 1528k may enable the worker to use tools to create an effective beginning and ending to the story. Tools the worker may use include the items described for the story page screen 1600 as well as an opening lines palette that lists sample opening lines, phrases, and opening scenes, a closing lines palette similar to the opening lines palette, and imagery tools that provides exercises and samples of imagery that can enhance the story through the use or metaphors or analogies, a graphics palette of drawing tools.

Buttons in the top sidebar area at the top of the story page screen 1600 facilitate story creation and easy navigation through the storytelling application 1132. Clicking on a timeline button 1616 allows the worker to include links to a case create window (see FIG. 14). A new page button 1618 creates a new page after the page being viewed. Using the new page button 1618 prevents the worker from having to go back to the story create screen 1500 to add a new page to the story. Similarly, clicking on a delete button 1620 deletes the current page without jumping back to the story create screen 1500. The worker can, however, access the story create screen 1500 by clicking on a storyline button 1622. Alternatively, the worker can close the story page screen 1600 by clicking on a close button 1624.

Referring back to FIG. 15, once the pages of the story are created, the worker can use buttons in the top sidebar area to finalize, e.g., test and post, the story. Clicking a test button 1536 triggers the storytelling application 1132 to test the story for effectiveness, consistency, and completeness as indicated in other stories and/or in criteria built or programmed into the create application 522. The testing may include checking for story elements including number of characters, lessons learned, a complete index, statements of emotion versus facts (a text pattern match), use of descriptions (adjectives), use of multiple perspectives (a text pattern match), use of timeframes, and match of phrases to the story type. For example, if the story type is a metaphor, the storyteller application 1132 checks the story's pages 1528 for metaphor keywords or phrasing and indicates on the story create screen 1500 if none are found, e.g., with a flag. The worker can-click on a post for review button 1538 to make the story available to particular people (selected by the story creator) for review via the gallery application 524. With or without review, the worker can click on a post final button 1540 to make the story available through the electronic infrastructure 500. Posting the final story triggers the electronic infrastructure to index the story and make it available to workers with proper access rights. Additionally, indexing the story makes it available for display as an alert on the appropriate initial/overview, customer, and project screens.

Once the story is created, the storytelling application 1132 provides for storing, retrieving, and editing the story. The resulting story is saved in segments so that relevant parts can be reused in another story and to facilitate searches for a smaller “chunk” of knowledge. The “chunks” from saved documents can later be found and incorporated into future documents/stories/results. This enables workers to shorten the development time of documents, proposals, etc. and utilize items that have already been researched, developed and proven successful. The worker may view and change/edit found documents, although the creator of the original document can grant permission/access to others to change/edit his or her document.

Another create application 522 is a scenario builder application 1134 that includes two sections: a create section and a play (“what if”) section. The create section enables the worker to describe a situation in one or more scenario, analyze options and decision factors, and identify the most likely scenarios. This creation is about reviewing what the worker knows, projecting what is possible, and analyzing known data to make informed decisions. Information collected in the create section can be-used in conjunction with preset simulation criteria in the play section. The play section is a multi-worker simulation that focuses the participants on working through a scenario described in the create section. By working through a scenario, the participants are able to introduce new factors, evaluate the effectiveness of responses and participants, and draw from existing libraries of cause-and-effect situations within the simulations. Therefore, the combination of defined elements and preset elements creates a scenario walkthrough for a team.

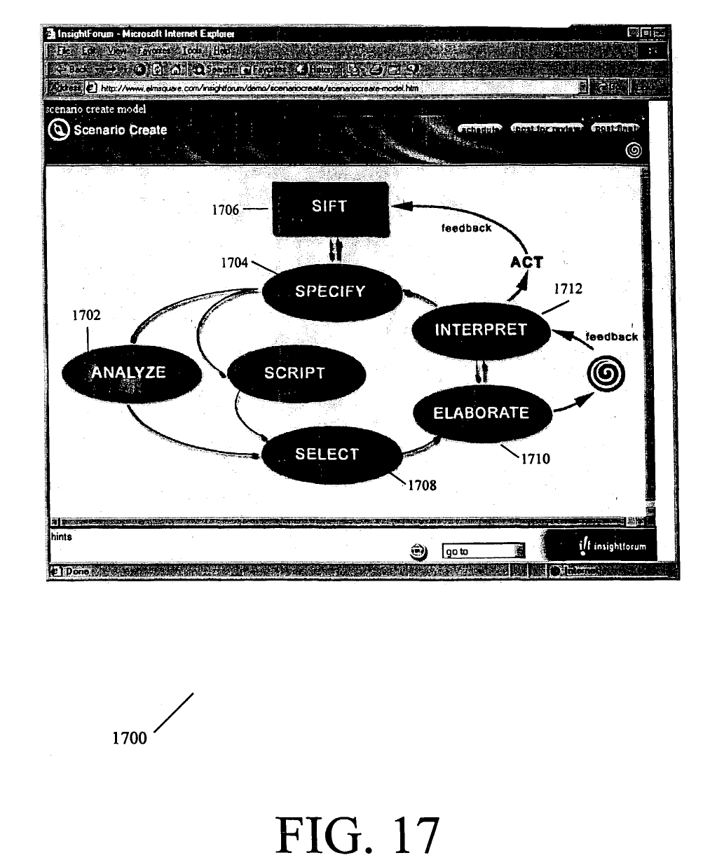

The create section of the scenario builder application 1134, as shown on a scenario create screen 1700 in FIG. 17, functions like the storytelling application 1132, but the results of the scenario builder application 1134 are output to a game database to affect the game environment 532. In effect, a scenario is like a future story: once a worker uses the scenario builder application 1134 and decides how to approach a given task, the worker can create a story using the storyteller application 1132.

Using create buttons on the scenario create screen 1700 facilitates the scenario creation First the worker can identify a situation. With an analyze button 1702, the worker can identify/analyze organizational issues that provide decision focus. Decision types include capital expenditures, diversification/divestment, account penetration, and product extension. The analyze button 1702 may also enable the worker to identify/analyze key external microenvironmental factors such as changes in customer dynamics/organization and competitive product information and key macroenvironmental factors such as industry state, economics, politics, and demographics. With a specify button 1704, the worker can specify key decision factors such as competitive threat, relationship stability, availability of resources, and changing technology. With a sift button 1706, the worker can establish scenario logic and prioritize high-impact scenarios to prepare for. With a select button 1708, the worker can determine if the scenario is plausible, differentiated, consistent, useful, and/or challenging. With an elaborate button 1710, the worker can describe/create a story (like with the create application 522) and/or competitive descriptions. With an interpret button 1712, the worker can interpret scenarios for decision purposes, looking at the scenario from the perspective of opportunity/threats, testing (playing), and developing alternative strategies.

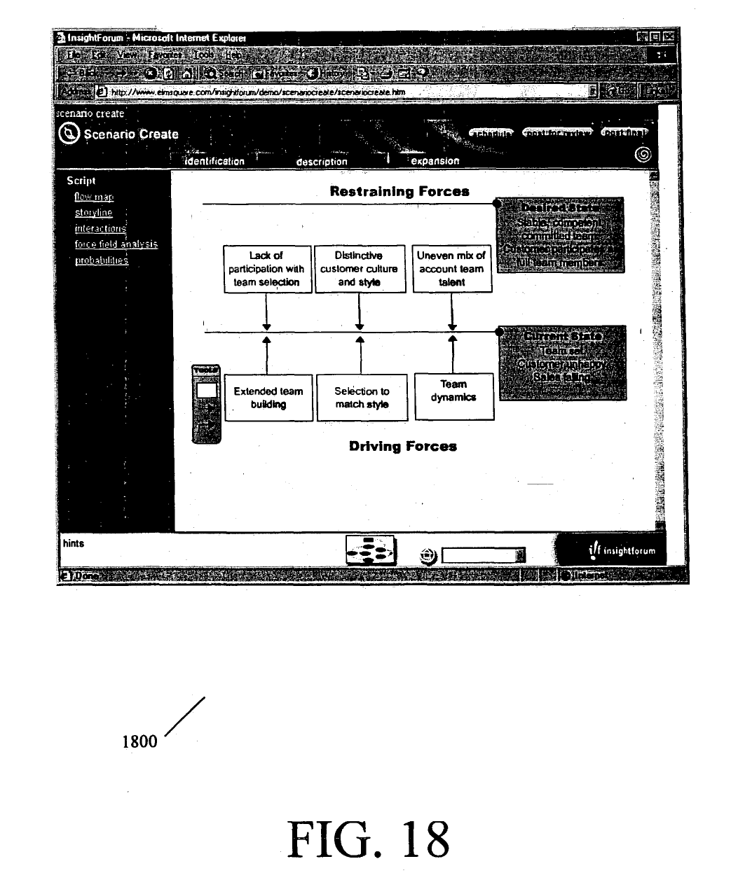

The scenario builder application 1134 also provides a way to create past scenarios and project future “what if” scenarios with a “what if” scenario builder application 1136. The scenario builder application 1134 walks a worker through a scenario-recording process on the scenario create screen 1700 and on a scenario script screen 1800 (FIG. 18) that feeds into a simulation engine in the game environment 532. (Someone creates a real-world scenario using a situation that happened to him or her. This scenario is available to other workers to practice on through the simulation.) This is a structured, guided creation, with the results stored in a database to be available in other applications, i.e., simulation. The results may be a way to keep record of a project: time, team, interactions, schedules, issues, solutions, etc.

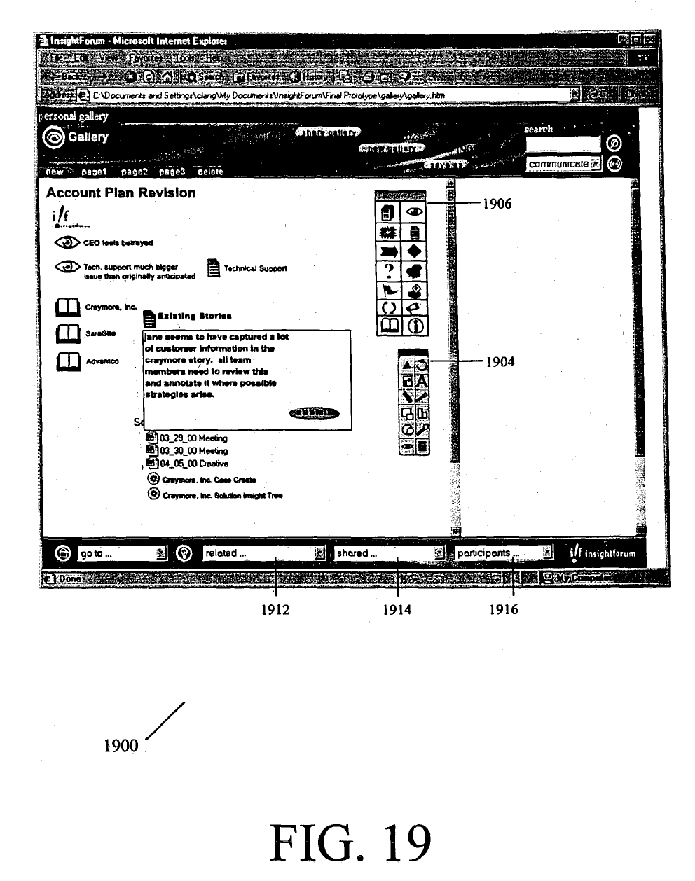

FIG. 19 shows a personal gallery screen 1900 reflecting another high-level application, a gallery application 524. The gallery application 524 collects a worker's or a group's (not shown) documents/pieces/stories/records in one “place” which can be accessed for reference and viewed by others (by invitation or access rights) for feedback/comments. The personal (worker) gallery and the group gallery function the same, but access rights and documents stored in the two galleries may differ. In the personal gallery, other workers can view the gallery, share the gallery, and access some comment and rating tools. In the group gallery, all participants can contribute to the gallery, although the group gallery owner may have additional access rights. The gallery 524 is a visual application, enabling the worker to reorganize and reconnect items he or she has worked on or constructed. With the gallery application 524, the worker can:

limit access to the “place,” such as by individual, team, or community and invite review;

provide read-only documents to visitors; and

use a polling application to receive feedback/comments.

Documents included in the gallery application 524 may be automatically or manually posted. Automatically posted documents and records include awards, certificates, and feedback reports from other activities within the electronic infrastructure 500. Workers can manually add a document to the gallery application 524 by clicking on a new gallery button 1902. Manually posting documents allows the workers to add information, graphics, and commentary to a gallery using a graphics palette 1904, an add palette 1906, and a navigation palette (not shown). The graphics palette 1904 (also available in the create application 522) includes drawing tools such as shapes, text, colors, and icons. The add palette 1906 includes tools to create new or summary notes, delete notes (available to the gallery owner only), and add links (the ability to display relationships between notes with lines or arrows). Summary notes include groupings of existing items with a “rise-above” comment. The navigation palette enables the worker to add buttons/links to other views or notes. Documents can also be dragged and dropped from collections and within the gallery application 524. Additionally, workers can flag comments with preset phrases (search identifiers) such as “I think,” “my hypothesis is,” and “I have an insight.”

A number of drop-down menus in the bottom sidebar area provide the worker with information relating to the currently viewed gallery. A related drop-down menu 1912 exposes galleries related to the currently viewed gallery. A shared drop-down menu 1914 displays galleries that the worker can access. A participants drop-down menu 1916 shows workers or groups that can access the currently viewed gallery. A group gallery may also have a schedule/participant drop-down menu or window displaying properties of the currently viewed gallery such as schedule, owner, and participant.

Once created, a document can be saved by clicking on a save as button 1908 and shared with other workers and groups by clicking on a share button 1910. From the group gallery, the share button 1910 can also share the gallery with extended communities and others. Created galleries may be automatically or manually ranked to generate top ten, worst ten, favorites, most used, etc. gallery lists.

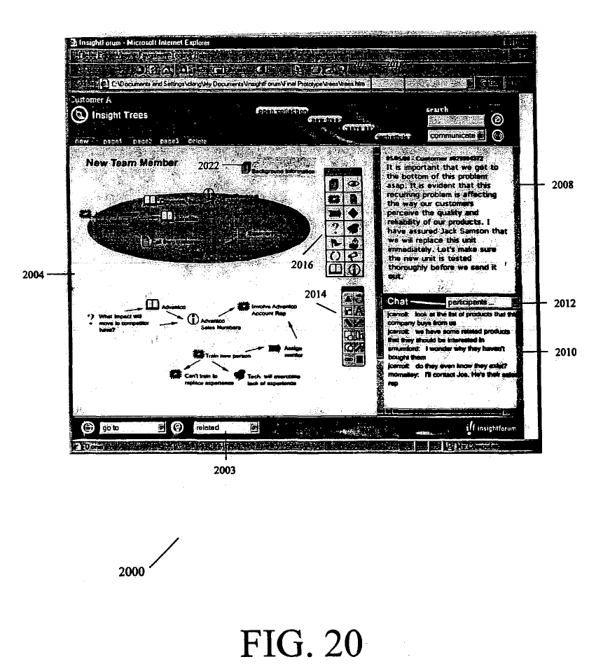

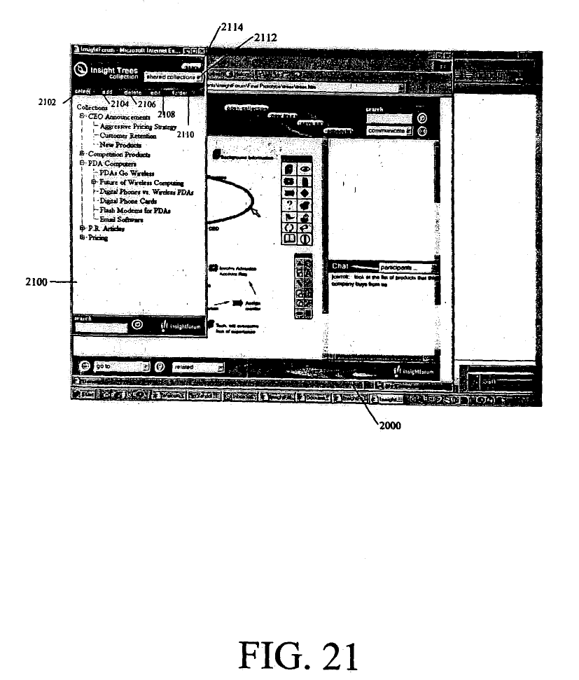

FIG. 20 shows a tree screen 2000 reflecting another high-level application, a tree application 526. The tree application 526 is a knowledge mapping tool, used to gather and organize bits of information, bundle them, give them new context (in a tree) with commentary, and make them available for review. Trees can be group (as on the tree screen 2000) or personal (as in FIG. 21, discussed below). Group trees visually display in real-time the thought processes of teams so that the teams that evaluate how decisions are made and track decisions leading to a certain point. Individual trees, called collections, allow workers to categorize and organize their favorite bits of information and to share their collections with other workers.

To create a new tree, the worker can click on a new tree button 2002. The worker may then be presented with preset templates. The worker may access saved trees via a related trees drop-down menu 2003. However accessed, trees are displayed in a tree window 2004 on the tree screen 2000. Also included on the tree screen are a link to background information 2022, a notes window 2008 and a chat window 2010. The notes window 2008 could include information from the create application 522, such as a storyline. The chat window 2010 includes any real-time chat involving members of the worker's group. The worker can choose a chat to join by clicking on a participate button 2012. Discussion threads can be incorporated to comment on the bundles.

Building a tree involves creating a tree and adding information to the tree. To create a tree, the worker can use a number of palettes as described above with reference to the gallery and FIG. 19. In particular, the worker may use a graphics palette 2014, an add palette 2016, and a navigation palette (not shown). These palettes may also be used to edit an existing tree. Creating a new tree involves:

giving the tree view a title, topic, and participant list;

creating a tree background using the graphics palette 2014;

establishing a view timeline, e.g., time to participate and time to close view; and

scheduling, using a schedule button 2018, a synchronous or asynchronous session with participants with subsequent invitations.

Once created, the tree can be saved by clicking a save as button 2020. Trees can be saved individually (without other application trees per group) to be saved to the gallery application 524.

Adding to a tree involves adding information, graphics, and commentary to the tree. Workers can:

drag information to the tree from a personal collection (described below);

add information through notes (in the notes window 2008);

add information establishing links to other items outside this or other trees;

add graphic elements via the graphics palette 2014;

add links between elements in the tree to show relationships and parent/child relationships;

add navigational elements; and

add summary notes encompassing and referencing other items in the tree.

Gathering information for a tree includes collecting and organizing information. Collecting information includes selecting sections of web pages and documents (text, graphics, video/audio clips, links, etc.) and copying the selections into a personal collection.

FIG. 21 shows a collection screen 2100 opened over the tree screen 2000. To open a new collection, the worker can click on an open collection button 2006. To access shared collections (from other groups), the worker can use a shared collections drop-down menu 2112. If not automatically created for a selection, as for a web site URL (uniform resource locator), the worker can input a title/keyword to identify fields or origin of selections in the collection. In the collection screen 2100, the worker can click a select button 2102 to select a location in the collection to store the selections. To add items, the worker can click on an add button 2104. Items that may be added include selections, categories, and directories. The items may be nested. Clicking on a delete button 2106 deletes the selected item from the collection. Clicking on an edit button 2108 opens properties of the selected item.

Organizing information in the collection screen 2100 includes organizing a collection through a hierarchical directory structure. By clicking on a folders button 2110, the worker can create categories (folders), delete categories, delete/move/edit stored information including title/keyword but not content, and view stored information and title/keywords/origin URL. Once information is collected and organized, the worker can choose which individuals to share his or her collection with by clicking on a share button 2114. The default sharing option includes the worker's group.

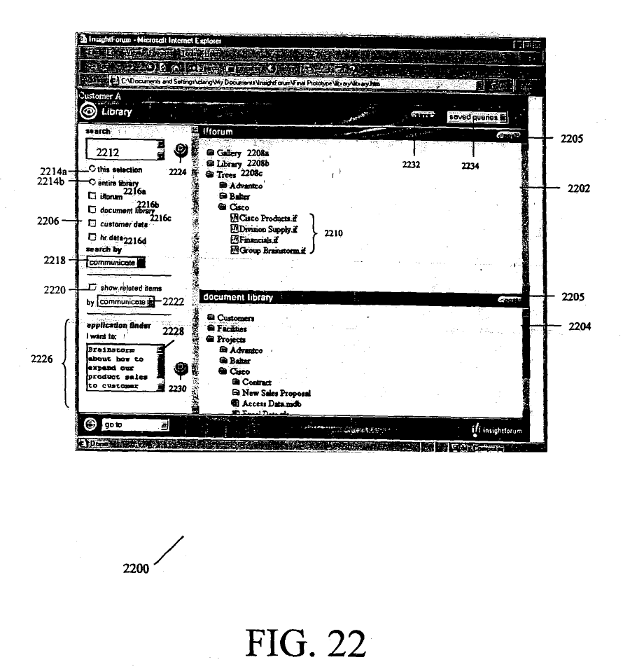

FIG. 22 shows a library screen 2200 reflecting another high-level application, a library application 528. The library application 528 provides knowledge management within the context of the current screen (filtered by client/project issue) in an applications library window 2202 and a documents library window 2204 display documents. The worker, however, can be given the opportunity to broaden search criteria beyond the current screen, if he or she chooses, via a library search window 2206. The search engine in the search window 2206 can search across multiple databases and document storage areas including information infrastructure databases, organization data, company data, processes, and projects. The search engine provides a list of found items, possibly ranked or rated per relevancy, polling results, or other worker criteria. The worker can click on a document/activity/data title within the “search” results and go immediately to that item for viewing/review. From there, the worker has multiple choices on what to do with that document, i.e., include within a gallery, post to a project team, etc. Rather than posting individual documents to a team or project group, the worker can post the search query into a common area/location that relates to a specific project/customer/discussion/issue. Clicking on the query link-produces the (updated/current) search results.

More specifically, the applications library window 2202 and the documents library window 2204 allow the worker to view available documents included in the electronic infrastructure 500. The applications library window 2202 is used to display “files” created using the electronic infrastructure's applications 1100. The applications 110 are identified by folder 2208 and organized within each folder by customer or project. Thus, documents are organized by “type” of file, i.e., tree documents 2210 are under the trees folder 2208c and all stories would be under project stories. Displayed documents are based on context upon entry to the library application 528. So, if coming from a particular customer's project, that customer group's documents are displayed. The documents library window 2204 is dedicated to the directory structure and/or document library for the current group (project), either of which could be any setup the organization uses for document management. In both the applications library window 2202 and the document library window 2204, the worker can:

browse up and down the directory structure;

open documents from the directory, e.g., by clicking on the document name;

preview documents if preview type is available;

view/toggle is a document is posted in a group gallery; and

add a document to his or her personal gallery using a post button 2205.

The library window 2206 allows the worker to search documents and applications for concepts (the default), applications, keywords, or customer, as chosen in a search by drop-down menu 2218. (The search engine capabilities accessible from the other electronic infrastructure applications pulls up a window similar or identical to the library window 2206.) The worker can enter search criteria in a search box 2212 that is two lines long by default. The area to be searched is selected by choosing one of two radio buttons 2214: this selection/project 2214a (search within the document set for the project from which the library screen 220 was entered) or the entire library 2214b (search within this project and all other available documents in the library). For both options, the areas searched (and the documents returned) depend on the worker's access rights. The worker may also select one or more checkboxes 2216 indicating the data to be searched: electronic infrastructure documents 2216a, document library 2216b, customer databases 2216c, and human resources databases 2216d. The worker may also check a show related items box 2220 to show items related to the search results. The items shown can be selected in a related items drop-down menu 2222 that includes options for concepts, applications, keywords, customer, and none of the above. The search is launched by clicking on a search button 2224.

An application finder 2226 allows the worker to search for the application(s)—that could help the worker carry out a particular task. The worker enters a search phrase in an application search window 2228 and launches the search by clicking on an application search button 2230.

To save a search, including all search parameters, made via the search box 2212 or the application finder 2226, the worker can click on a save button 2232. Activating the save button 2232 launches a prompt for a title and location for saving. To retrieve a saved search, the worker can pull down a saved queries drop-down menu 2234 and select a listed title (specific to that group) to launch that query.

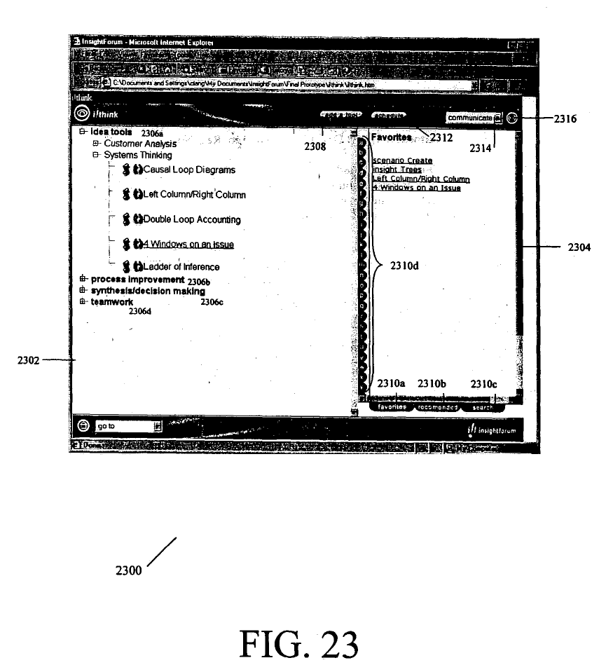

FIG. 23 shows a tools screen 2300 reflecting another high-level application, authoring (think) tools 530. The authoring tools 530 allow the electronic infrastructure 500 to quickly build applets and provide content with a consistent interface/look and feel. Pieces of content to be delivered include tools, forms, learning activities, and exercises. The content is short, includes various levels of interactivity, and provides mini tutorials similar to traditional learning resources.

This content can be delivered in a toolbox window 2302 or a side window 2304. The toolbox window includes a list of tools folders 2306. The tools folders may include an idea tools folder 2306a, a process improvement folder 2306b, a synthesis/decision-making folder 2306c, and a teamwork folder 2306d, although tool folders may be added using an add button 2308. The side window includes windows accessible by tabs 2310. The tabs may include favorites 2310a, recommendations 2310b, search 2310c, and alphabetical contacts tabs 2310d. The worker can at any time in the tools window 2300 schedule collaboration between workers using a schedule button 2312 or a communicate drop-down menu 2314 (launched via a communicate icon 2316).

Another high-level application is the game environment 532. As described above, the game environment 532 is a highly graphic, simulation environment that can be utilized as a learning tool. The game environment 532 is therefore structured in a manner that enables collaboration, multiple players/workers, research, and the ability to explore various “what if” scenarios. The game environment 532 is a persistent world where things/life continues rather than stops if player leaves. A worker's game persona 1140 continues and develops based on what the worker does within the applications and on various levels and tools, weapons, and powers he or she acquires through interaction and experience. Filters use the game persona 1140 to determine what activities 1142 the worker can do in the game environment, what roles 1144 the worker can play, what level 1146 he or she plays at (mentor, novice, etc.), and what areas of the game world he or she can access.

When the worker enters the game environment 532, an administration application 1148 processes the worker, providing the worker with registration, badge pick-up, and people connections based on the worker's persona. Also, the worker's game persona 1140 has access to areas of the world dependent on who he or she entered as (from a particular client, etc.). There may be a finite number of roles 1144, levels 1146, and allowable players. Each game persona 1140 runs into other game personas 1140 from different clients, issues, etc. and works with them. Expert observers in the game environment 532 (determined by persona levels) can affect the game by entering data and/or helping and giving feedback.

The game world is built by workers and is influenced by “real world” activity. Real world data is fed into the game environment through other interactions between team members within other applications. The results of these interactions can be “read” by the game environment 532 and incorporated to affect the playing environment negatively or positively. Outside forces which might influence the playing environment include:

“floods;”

mergers and acquisitions;

hostile takeovers;

customer defections;

market fluctuations;

supply shortages; and

strategy changes.

All applications 1100 are available through the game environment 532 and can contribute to the changes in the game environment 532. In particular, workers may use a virtual meeting room to view a posted schedule or discussion thread or to search for mentors/coaches. The gallery application 524 and the library application 528 may let the worker easily and quickly find his or her own or others' work that could be helpful in the game environment 532.

In an example of a worker using the electronic infrastructure, a press release from a newspaper (an outside data source accessed via the Internet) appears on the worker's initial/overview screen on the news list. The press release indicates that the worker's number one customer is the subject of a hostile takeover. As team leader in charge of that customer, the worker initiates actions using the electronic infrastructure. The worker notifies his or her team and electronically schedules an A.M. Monday virtual meeting. Upon scheduling the meeting, the electronic infrastructure automatically:

notifies the worker's team of the meeting;

retrieves the active relationship history on the customer including stories and lists of key contacts (past and present);

lists internal and external experts on mergers and acquisitions and hostile takeovers;

creates an extended virtual community, including meeting spaces, work spaces, instant messaging, thinking posts, discussion threads, and team and customer email filters; and

creates and electronically briefs an extended team including technical, marketing, and relationship personnel to supplement the core team.

At the A.M. Monday virtual meeting, since the core team members have never worked in this situation before, they are immediately invited to the game environment where they may experiment with a similar situation. The game environment and/or the electronic infrastructure automatically:

sets up the game environment with materials describing the organizations' experience with mergers and acquisitions (including recent strategies used by other teams) and with learning modules about hostile takeovers;

identifies skills and profiles of the team members;

identifies internal and external experts who are available online for questions; provides a set of tools, e.g., the gallery application to access stories and the create application to test “what-if” scenarios; and

records and thematically organizes team dialogue and decisions into a map.

At the A.M. Monday virtual meeting, new team members learn merger and acquisition principles. Relationship metrics may be gathered from CRM data. One team member sets up a legal advisory group within the organization and identifies outside legal sources. Another team member outlines tasks. A third team member works with the organization's investment bank to test scenarios. A separate file is create on the takeover company, who is also a customer.

After the A.M. Monday virtual meeting during Monday afternoon and Tuesday morning, team members draft a strategy in a shared team document to test with experts. One person organizes research into an action report with key decision points and criteria. The electronic infrastructure continues to download selected, relevant stories to team members' desktops. It also automatically tracks, sorts, and filters communications across teams and updates active file history as new information is gathered.

On Tuesday afternoon, the strategy in the shared team document is tested during role play. A P.M. Tuesday virtual meeting is scheduled with key experts and senior executives to discuss results of the role play. In the role play, a member of the legal team tests legal implications of contacting clients at both companies and the attitudes of the customer company. The electronic infrastructure automatically:

monitors the game activity and notifies the team to participate;

initiates multi-worker role play;

records team dialogue and decisions and shares it with experts;

identifies experts who are online and available for questioning via instant messaging;

provides recent scenarios used by other teams; and

provides dialogue and collaboration tools to facilitate discussion.

At the P.M. Tuesday virtual meeting, the team debriefs the experts and executives about the strategy draft and the role play. Together the meeting participants create a second strategy draft. Input from sources inside the two customer companies are integrated into scenarios that may be used in the second strategy draft.

On Wednesday morning, the team engages a team at the customer in online dialogue and brainstorming. The team knows when to contact the customer because the electronic infrastructure automatically tracks team communications and schedules and recommends several customer call times. When the team decides upon a time, the electronic infrastructure schedules the meeting with the customer team. At the online discussion, one member summarizes ideas to incorporate into research into an action plan. Customer recommendations are incorporated and shared with experts for suggestions. During this online discussion, the electronic infrastructure automatically:

updates active file history into web folders;

streams news stories and analysis; and

generates competitive archives on acquiring company suppliers.

For Wednesday afternoon, the electronic infrastructure schedules a P.M. Thursday virtual meeting with key influencers in the customer account to hear a final draft strategy and information exchange presentation. At the P.M. Thursday virtual meeting, the customer and account teams meet, exchange information, share strategy documents, and plan joint activities for months ahead. Introductions to key contact people in the acquiring company are planned. Network of influencers will be extended to include acquiring company and strategic partners.

At the conclusion of this final virtual meeting, the electronic infrastructure automatically:

distributes a URL for dialogue transcript summary and analysis;

updates tasks metrics with new data and future agenda;

updates active history file with final strategy proposal;

sets up customer measurement process to track proposal;

identifies follow-on learning suggestions to each team member based upon peer-assessed performance in the game environment;

updates HRIS experience files for each team member as part of automatic monthly “intellectual accounting;”

updates team expertise profiles; and

recommends two team members for a team award based on expert evaluation.

In another example of a worker using the electronic infrastructure, a call report appears on the worker's initial/overview screen on the alerts list. The call report is from a senior executive and indicates that a key influencer on the worker's customer team is leaving the organization to take a new job. In response, the electronic infrastructure automatically:

flags the customer's account;

notifies workers associated with the customer;

creates and electronically briefs an extended team including technical, marketing, and relationship personnel to supplement the core team;

provides assignments to workers based on a worker's last interactions with the customer; and

schedules a customer-product review virtual meeting.

At the virtual meeting, the team members can develop a planning strategy and make or adjust team assignments. The team assignments include developing specific account plans including revisions of communications strategies, value propositions, relationship maps, and competency requirements. The account plans are evaluated collaboratively and virtually using application sharing and team innovation and brainstorming tools. The electronic infrastructure automatically:

provides a story template;

provides a set of account planning, systems thinking, and decision-making tools within the game environment (where the virtual meeting is taking place) for testing “what is' scenarios;

updates the game environment with industry data and news;

records and thematically organized team dialogue and decisions;

identifies internal and external experts who are available online for questions; and

provides recent strategies used by other teams.

Once the account plans are evaluated at the virtual meeting, a virtual customer meeting is scheduled. At this virtual meeting, email, chat, and other communications channels are open with the customer team. In addition to the functions described for the virtual meeting above, the electronic infrastructure generates a relationship map that tracks communications patterns between the organization and the customer, including all service, sales, and product presentation calls, inquiries, and mailings. After meeting with the customer, the extended team comes to a face-to-face meeting with the core account team to review and synthesize customer analysis data and to jointly develop strategy. Then, the organization's teams can meet face-to-face with customer teams to jointly develop specific account plans including revisions of communications strategies, value propositions, relationship maps, and competency requirements.

Other embodiments are within the scope of the following claims. For example, the invention can be used to aid workers who are involved in other aspects of enterprise other than customer relations, such as product development, strategic planning, or manufacturing. The particular tools and applications that enable the worker to work and learn simultaneously using the same infrastructure could be different from the ones discussed above. The invention is applicable to groups other than workers in a business enterprise. The working and learning contemplate by the invention could engage workers from multiple independent enterprises.

What is claimed is:

1. A method comprising:
electronically enabling people who belong to an enterprise to define a goal that is related to managing a relationship with a customer of the enterprise;
providing a graphical user interface that enables the people to cooperate to make complex decisions that will advance the achievement of the goal; and
providing features in the interface that enable the people to make the complex decisions in a manner that inherently and continually improves their ability to make subsequent complex decisions.

2. The method of claim 1 in which the goal comprises improving customer satisfaction.

3. The method of claim 1 in which the features provided in the interface include access to desktop applications for creating documents, maintaining databases and spreadsheets, and managing projects.

4. The method of claim 1 in which the features provided in the interface include access to enterprise customer relationship databases.

5. The method of claim 1 in which the features provided in the interface include access to filtered lists.

6. The method of claim 1 in which the features provided in the interface include access to collaboration tools.

7. The method of claim 1 in which the features provided in the interface include access to assessment and growth tools.

8. The method of claim 1 in which the features provided in the interface include a game environment that enables a user to conduct a simulated activity associated with managing a customer relationship.

9. The method of claim 1 in which the features provided in the interface include authoring tools that guide a user in writing a story related to managing a customer relationship.

10. The method of claim 1 in which the interface is arranged to include a displayed area that identifies customers with which the user of the interface is associated.

11. The method of claim 1 in which the interface is arranged to include a displayed area that identifies customer projects with which the user of the interface is associated.

12. The method of claim 1 in which the interface is arranged to include a displayed area that identifies sources of filtered information that is relevant to the activities of the user of the interface.

13. The method of claim 1 in which the interface is arranged to include a displayed area that enables a user of the interface to invoke customer management tools that enable the user to participate in making complex decisions in a manner that inherently and continually improves his ability to participate in making subsequent complex decisions.

14. The method of claim 1 in which the interface is customized for each user to provide the user only with those tools and information that he is permitted to access and that are relevant to his work in managing customer relationships.

15. A method comprising:
generating an overview computer screen for a worker, the overview screen containing information on one or more customers associated with the worker and information on one or more projects associated with the worker;
generating a customer computer screen for a customer on the overview computer screen when the worker requests information on the customer;
generating a project computer screen for a project on the overview computer screen when the worker requests information on the project; and
filtering the information on the overview, customer, and project screens based on an access level of the worker.

16. article comprising a computer-readable medium which stores computer-executable instructions, the instructions causing a computer to:
provide workers in an organization with access to a customer interface environment including data on customers of the organization and projects related to the customers and to a game environment providing simulations of real-world scenarios involving the customers and the projects; and
allowing the workers to freely switch between the customer interface environment and the game environment.

17. An article comprising a computer-readable medium which stores computer-executable instructions, the instructions causing a computer to:
store data on a number of customers associated with an organization;
store data on a number of projects related to the customers; and
automatically provide a worker in the organization with data received from sources internal to and external to the organization relating to customers and to projects associated with the worker.

18. An electronic game environment comprising:
simulated personas of parties to the game, the personas being defined in a manner that relates to customer relationship management, simulated roles of parties of the game, the roles being defined in a manner that relates to customer relationship management, simulated activities that relate to customer relationship management, and simulated levels of play that relate to different levels of complexity of customer relationship management.

19. An electronic story creation environment comprising:
a storyteller facility in which a user can enter elements of a story, a scenario builder that enables a user to create a scenario associated with a story,
a what-if scenario builder that enables a user to create a scenario associated with alternative possible hypotheses, and
a case create facility that enables a user to format the story as a case for later use.

20. An electronic user interface comprising:
a map that illustrates relationships among members of a team working on an enterprise management task,
the relationships being illustrated in a manner that identifies the significance of the role of each member within the team,
the relationships being illustrated in a manner that identifies the frequency of interaction of the user of the interface with other members of the team.

21. An electronic user interface comprising:
a map that illustrates relationships between a user of the interface and a set of people who represent mentors of the user, and
windows that display details about each of the mentors.

22. An electronic user interface comprising:
a facility that automatically assembles and displays a history of communications and activities among members of a team who are working on an enterprise task, and
a facility to annotate and manipulate the information in the window to form the history into a case that can be studied by others who are working on similar tasks.

23. An electronic user interface comprising:
a facility that guides a user in creating a story associated with an enterprise task,
the facility including a graphical display of portions of a story in accordance with a selected one of a set of predefined story themes.
